(19) United States
(12) Patent Application Publication
(10) Pub. No.: US 2026/0322706 A1
(43) Pub. Date: Oct. 15, 2026

(54) COMMUNICATION METHOD AND APPARATUS, AND COMMUNICATION DEVICE AND COMMUNICATION SYSTEM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/484,513

(22) PCT Filed: May 15, 2023
(86) PCT No.: PCT/CN2023/094378

§ 371 Date: Nov. 14, 2025

(51) Int. Cl. H04L 41/16; H04W 16/22

(52) U.S. Cl. CPC H04L 41/16; H04W 16/22

(57) ABSTRACT

A communication method includes determining first information, where the first information is used for determining a state of a terminal for performing communication based on an AI model or an AI function. The method further includes determining, based on the first information, whether to configure the AI model or the AI function.

### CROSS-REFERENCE TO RELATED APPLICATION

The present application is a U.S. National Stage of International Application No. PCT/CN2023/094378, filed on May 15, 2023, the entire content of which is incorporated herein by reference for all purposes.

### TECHNICAL FIELD

The present disclosure relates to the field of communication technology, particularly to a communication method and apparatus, a communication device and a communication system.

### BACKGROUND

Artificial intelligence (AI) technology has made continuous breakthroughs in a plurality of fields. Applying the AI technology for communication processing in wireless air interfaces, including training of AI models and inference applications of models, assists in improving the transmission technology of the wireless air interfaces.

### SUMMARY

Embodiments of the present disclosure propose a communication method and apparatus, a communication device, and a communication system.

According to a first aspect of the embodiments of the present disclosure, there is provided a communication method performed by a network device. The method includes: determining first information, where the first information is used for determining a state of a terminal for performing communication based on an AI model or an AI function; and determining, based on the first information, whether to configure the AI model or the AI function. The method is used for avoiding the processing overload of the terminal, and improving the communication efficiency of the communication.

According to a second aspect of the embodiments of the present disclosure, there is provided a communication method performed by a terminal. The method includes sending first information, where the first information is used for indicating a state of the terminal for performing communication based on an AI model or an AI function, and the first information is used for a network device to determine whether to configure the AI model or the AI function.

According to a third aspect of the embodiments of the present disclosure, there is provided a communication method for a communication system. The method includes: determining, by a network device, first information, where the first information is used for indicating a state of a terminal for performing communication based on an AI model or an AI function, and the first information is used for the network device to determine whether to configure the AI model or the AI function; and determining, by the network device based on the first information, whether to configure the AI model or the AI function for the terminal.

According to a fourth aspect of the embodiments of the present disclosure, there is provided a communication device including one or more processors; where the processor is configured to invoke an instruction to cause the communication device to perform the communication method described in any one of the first aspect and the second aspect.

According to a fifth aspect of the embodiments of the present disclosure, there is provided a communication system including a terminal and a network device, where the terminal is configured to implement the communication method described in any one of the second aspect, and the network device is configured to implement the communication method described in any one of the first aspect.

According to a sixth aspect of the embodiments of the present disclosure, there is provided a storage medium, where the storage medium stores an instruction, and the instruction, when run on a communication device, causes the communication device to performs the communication method described in any one of the first aspect and the second aspect.

### BRIEF DESCRIPTION OF THE DRAWINGS

To more clearly illustrate the technical solutions in the embodiments of the present disclosure, the following provides an introduction to the accompanying drawings required for the description of the embodiments. The accompanying drawings below are merely some embodiments of the present disclosure, and do not impose specific limitations on the scope of protection of the present disclosure.

FIG. 1 is a schematic architecture diagram of a communication system illustrated according to an embodiment of the present disclosure.

FIG. 2 is a schematic interaction diagram of a communication method illustrated according to an embodiment of the present disclosure.

FIG. 3a is a flowchart of a communication method illustrated according to an embodiment of the present disclosure.

FIG. 3b is a flowchart of a communication method illustrated according to an embodiment of the present disclosure.

FIG. 3c is a flowchart of a communication method illustrated according to an embodiment of the present disclosure.

FIG. 3d is a flowchart of a communication method illustrated according to an embodiment of the present disclosure.

FIG. 4a is a flowchart of a communication method illustrated according to an embodiment of the present disclosure.

FIG. 4b is a flowchart of a communication method illustrated according to an embodiment of the present disclosure.

FIG. 4c is a flowchart of a communication method illustrated according to an embodiment of the present disclosure.

FIG. 5 is a flowchart of a communication method illustrated according to an embodiment of the present disclosure.

FIG. 6A is a schematic diagram of a first communication apparatus illustrated according to an embodiment of the present disclosure.

FIG. 6B is a schematic diagram of a second communication apparatus illustrated according to an embodiment of the present disclosure.

FIG. 7A is a schematic diagram of a communication device illustrated according to an embodiment.

FIG. 7B is a schematic structure diagram of a chip illustrated according to an embodiment.

### DETAILED DESCRIPTION

The embodiments of the present disclosure propose a communication method and apparatus, a communication device, and a communication system.

In a first aspect, an embodiment of the present disclosure proposes a communication method performed by a network device. The method includes: determining first information, where the first information is used for determining a state of a terminal for performing communication based on an AI model or an AI function; and determining, based on the first information, whether to configure the AI model or the AI function.

In the embodiment described above, the network device determines, based on the first information, the state of the terminal for performing communication, enabling the network device to determine, based on the state of the terminal for performing communication, whether to configure an AI model or an AI function for the terminal, avoiding the processing overload of the terminal and the inability of the terminal to perform communication based on the AI model or the AI function configured by the network device, thereby improving the communication efficiency. Based on some embodiments of the first aspect, in some embodiments, the first information is used for indicating at least one of the following:
the terminal accepting an AI model or an AI function configured by the network device;
the terminal rejecting the AI model or the AI function configured by the network device;
a total storage supported by the terminal;
a total computing power resource supported by the terminal;
an AI model or an AI function supported by the terminal;
a storage occupied by the AI model or the AI function supported by the terminal;
a computing power resource occupied by the AI model or the AI function supported by the terminal;
a maximum number of AI models or AI functions supported by the terminal;
a remaining computing power resource of the terminal;
a remaining storage of the terminal;
whether the terminal expects to be configured with an AI model or an AI function;
a number of AI models or AI functions simultaneously supported by the terminal;
electric power amount information of the terminal; and
a condition under which the terminal allows configuration of an AI model or an AI function.

In the embodiment described above, the network device can determine, based on the first information, the state of the terminal for performing communication, enabling the network device to determine, based on the state of the terminal for performing communication, whether to configure an AI model or an AI function for the terminal, avoiding the processing overload of the terminal and the inability of the terminal to perform communication based on the AI model or the AI function configured by the network device, thereby improving the communication efficiency. Based on some embodiments of the first aspect, in some embodiments, determining the first information includes receiving the first information.

In the embodiment described above, the network device, through receiving the first information sent by the terminal, determines the state of the terminal for performing communication, enabling the network device to determine, based on the state of the terminal for performing communication, whether to configure an AI model or an AI function for the terminal, avoiding the processing overload of the terminal and the inability of the terminal to perform communication based on the AI model or the AI function configured by the network device, thereby improving the communication efficiency.

Based on some embodiments of the first aspect, in some embodiments, the first information is used for indicating at least one of the following: a total storage supported by the terminal, a total computing power resource supported by the terminal, an AI model or an AI function supported by the terminal, a storage occupied by the AI model or the AI function supported by the terminal, and a computing power resource occupied by the AI model or the AI function supported by the terminal; and determining, based on the first information, whether to configure the AI model or the AI function includes: determining, based on the first information, a remaining storage and a remaining computing power resource of the terminal, and determining, based on the remaining storage and the remaining computing power resource of the terminal, whether to configure the AI model or the AI function.

In the embodiment described above, the network device determines, based on the remaining storage and the remaining computing power resource of the terminal, whether to configure the AI model or the AI function for the terminal, avoiding the communication failure caused by the remaining storage and the remaining computing power of the terminal being unable to guarantee the communication of the terminal based on the AI model or the AI function.

Based on some embodiments of the first aspect, in some embodiments, determining, based on the remaining storage and the remaining computing power resource of the terminal, whether to configure the AI model or the AI function for the terminal includes at least one of the following: if the remaining storage and the remaining computing power resource of the terminal support the terminal in accepting the configured AI model or AI function, determining to configure the AI model or the AI function; and if the remaining storage and the remaining computing power resource of the terminal do not support the terminal in accepting the configured AI model or AI function, determining not to configure the AI model or the AI function for the terminal.

In the embodiment described above, the network device determines, based on the remaining storage and the remaining computing power resource of the terminal, that the terminal can receive the configured AI model or AI function, and configures the AI model or the AI function for the terminal, avoiding the processing overload of the terminal, and improving the communication efficiency. The network device determines, based on the remaining storage and the remaining computing power resource of the terminal, that the terminal cannot receive the configured AI model or AI function, and determines not to configure the AI model or the AI function for the terminal, avoiding the processing overload of the terminal, and improving the communication efficiency.

Based on some embodiments of the first aspect, in some embodiments, the first information is used for indicating a maximum number of AI models or AI functions supported by the terminal; and
determining, based on the first information, whether to configure the AI model or the AI function for the terminal includes at least one of the following: if the maximum number of AI models or AI functions supported by the terminal is less than or equal to a number of AI models or AI functions currently configured for the terminal for performing communication, determining not to configure the AI model or the AI function for the terminal; and if the maximum number of AI models or AI functions supported by the terminal is greater than the number of AI models currently configured for the terminal for performing communication, determining to configure the AI model or the AI function for the terminal.

In the embodiment described above, the network device determines that the maximum number of AI models or AI functions supported by the terminal is less than or equal to the number of AI models or AI functions currently configured for the terminal for performing communication, and determines that the terminal cannot receive the configured AI model or AI function, and the network device does not configure the AI model or the AI function for the terminal, avoiding the processing overload of the terminal, and improving the communication efficiency. The network device determines that the maximum number of AI models or AI functions supported by the terminal is greater than the number of AI models or AI functions currently configured for the terminal for performing communication, and determines that the terminal can receive the configured AI model or AI function, and the network device configures the AI model or the AI function for the terminal, avoiding the processing overload of the terminal, and improving the communication efficiency.

Based on some embodiments of the first aspect, in some embodiments, the first information is used for indicating at least one of the following: the terminal accepting an AI model or an AI function configured by the network device, and the terminal rejecting the AI model or the AI function configured by the network device; and
determining, based on the first information, whether to configure the AI model or the AI function includes at least one of the following:
if the first information is used for indicating that the terminal accepts the AI model or the AI function configured by the network device, determining to configure the AI model or the AI function; and
if the first information is used for indicating that the terminal rejects the AI model or the AI function configured by the network device, determining not to configure the AI model or the AI function.

In the embodiment described above, after the network device configures the AI model or the AI function for the terminal, the terminal sends the first information as a receiving configuration or a rejecting configuration, enabling the network device to determine the state of the terminal for performing communication, avoiding the processing overload of the terminal, and improving the communication efficiency. If the first information is that the terminal receives the AI model or the AI function configured by the network device, it is indicated that the terminal is currently capable of processing the AI model or the AI function, and the network device can determine that it can configure the AI model or the AI function for the terminal again.

Based on some embodiments of the first aspect, in some embodiments, the first information is used for indicating at least one of the following: a remaining computing power resource of the terminal, a remaining storage of the terminal, and whether the terminal expects to be configured with an AI model or an AI function; and
determining, based on the first information, whether to configure the AI model or the AI function includes at least one of the following:
if the remaining computing power resource and the remaining storage of the terminal support the terminal in accepting the configured AI model or AI function, and the terminal expects to be configured with the AI model or the AI function, determining to configure the AI model or the AI function;
if the remaining computing power resource of the terminal does not support the terminal in accepting the configured AI model or AI function, determining not to configure the AI model or the AI function;
if the remaining storage of the terminal does not support the terminal in accepting the configured AI model or AI function, determining not to configure the AI model or the AI function; and if the terminal does not expect to be configured with the AI model or the AI function, determining not to configure the AI model or the AI function.

In the embodiment described above, the network device determines, based on the remaining storage and the remaining computing power resource of the terminal, that the terminal can receive the configured AI model or AI function, and the terminal expects to be configured with the AI model or the AI function, then the network device configures the AI model or the AI function for the terminal, avoiding the processing overload of the terminal, and improving the communication efficiency. The network device determines, based on the remaining storage and the remaining computing power resource of the terminal, that the terminal cannot receive the configured AI model or AI function, and/or if the terminal does not expect to receive a new AI model or AI function, then the network device determines not to configure the AI model or the AI function for the terminal, avoiding the processing overload of the terminal, and improving the communication efficiency.

Based on some embodiments of the first aspect, in some embodiments, the first information is used for indicating a number of AI models or AI functions simultaneously supported by the terminal; and
determining, based on the first information, whether to configure the AI model for the terminal includes: determining to configure the AI model or the AI function for the terminal, where a number of configured AI models or AI functions is determined based on the number of AI models or AI functions simultaneously supported by the terminal.

In the embodiment described above, the network device configures, based on the number of AI models or AI functions simultaneously supported by the terminal, the AI model or the AI function for the terminal, avoiding the processing overload of the terminal, and thus improving the communication efficiency.

Based on some embodiments of the first aspect, in some embodiments, the method further includes sending second information; where the second information includes at least one of the following: the second information is used for configuring the AI model or the AI function, and the second information is used for indicating the terminal to send the first information.

In the embodiment described above, the network device sends the second information to configure an AI model or an AI function for the terminal. Alternatively, the network device sends the second information to indicate the terminal to send the first information, causing that the network device can obtain the first information. This avoids the processing overload of the terminal, and improves the communication efficiency.

Based on some embodiments of the first aspect, in some embodiments, after the determining, based on the first information, to configure the AI model or the AI function, third information is sent, where the third information is used for configuring the AI model or the AI function.

In the embodiment described above, when the network device determines to configure the AI model or the AI function for the terminal, the network device may send the third information to configure the AI model or the AI function for the terminal.

Based on some embodiments of the first aspect, in some embodiments, after the sending the third information, the method further includes receiving fourth information, where the fourth information is used for indicating that the terminal accepts the AI model or the AI function configured by the third information, or the fourth information is used for indicating that the terminal rejects the AI model or the AI function configured by the third information.

In the embodiment described above, when the network device configures the third information for the terminal, the terminal can again determine, based on its own state, whether to receive the AI model or the AI function configured by the third information, avoiding the processing overload of the terminal, and improving the communication efficiency.

In a second aspect, an embodiment of the present disclosure proposes a communication method performed by a terminal. The method includes sending first information, where the first information is used for indicating a state of the terminal for performing communication based on an AI model or an AI function, and the first information is used for a network device to determine whether to configure the AI model or the AI function.

In the embodiment described above, the terminal sends the first information, causing that the network device can determine, based on the first information, the state of the terminal for performing communication. This enables the network device to determine, based on the state of the terminal for performing communication, whether to configure an AI model or an AI function for the terminal, avoiding the processing overload of the terminal and the inability of the terminal to perform communication based on the AI model or the AI function configured by the network device, thereby improving the communication efficiency.

Based on some embodiments of the second aspect, in some embodiments, the first information is used for indicating at least one of the following:
the terminal accepting an AI model or an AI function configured by the network device;
the terminal rejecting the AI model or the AI function configured by the network device;
a total storage supported by the terminal;
a total computing power resource supported by the terminal;
an AI model or an AI function supported by the terminal;
a storage occupied by the AI model or the AI function supported by the terminal;
a computing power resource occupied by the AI model or the AI function supported by the terminal;
a maximum number of AI models or AI functions supported by the terminal;
a remaining computing power resource of the terminal;
a remaining storage of the terminal;
whether the terminal expects to be configured with an AI model or an AI function;
a number of AI models or AI functions simultaneously supported by the terminal;
electric power amount information of the terminal; and
a condition under which the terminal allows configuration of an AI model or an AI function.

Based on some embodiments of the second aspect, in some embodiments, the first information is used for indicating at least one of the following: a total storage supported by the terminal, a total computing power resource supported by the terminal, an AI model or an AI function supported by the terminal, a storage occupied by the AI model or the AI function supported by the terminal, and a computing power resource occupied by the AI model or the AI function supported by the terminal.

The first information is used for the network device to determine a remaining storage and a remaining computing power resource of the terminal, and is used for the network device to determine, based on the remaining storage and the remaining computing power resource of the terminal, whether to configure the AI model or the AI function.

Based on some embodiments of the second aspect, in some embodiments, the first information is used for the network device to determine the remaining storage and the remaining computing power resource of the terminal, and is used for the network device to determine, based on the remaining storage and the remaining computing power resource of the terminal, whether to configure the AI model or the AI function, including at least one of the following: if the remaining storage and the remaining computing power resource of the terminal support the terminal in accepting the configured AI model or AI function, the first information is used for the network device to determine to configure the AI model or the AI function; and if the remaining storage and the remaining computing power resource of the terminal do not support the terminal in accepting the configured AI model or AI function, the first information is used for the network device to determine not to configure the AI model or the AI function.

Based on some embodiments of the second aspect, in some embodiments, the first information is used for indicating a maximum number of AI models or AI functions supported by the terminal; and
the first information is used for the network device to determine whether to configure the AI model or the AI function, including at least one of the following:
if the maximum number of AI models or AI functions supported by the terminal is less than or equal to a number of AI models or AI functions currently configured for the terminal for performing communication, the first information is used for the network device to determine not to configure the AI model or the AI function; and
if the maximum number of AI models or AI functions supported by the terminal is greater than the number of AI models or AI functions currently configured for the terminal for performing communication, the first information is used for the network device to determine to configure the AI model or the AI function.

Based on some embodiments of the second aspect, in some embodiments, the first information is used for indicating that the terminal accepts an AI model or an AI function configured by the network device, or that the terminal rejects the AI model or the AI function configured by the network device; and
the first information is used for the network device to determine whether to configure the AI model or the AI function, including at least one of the following:
if the first information is used for indicating that the terminal accepts the AI model or the AI function configured by the network device, the first information is used for indicating the network device to determine not to configure the AI model or the AI function; and
if the first information is used for indicating that the terminal rejects the AI model or the AI function configured by the network device, the first information is used for indicating the network device to determine not to configure the AI model or the AI function.

Based on some embodiments of the second aspect, in some embodiments, the first information is used for indicating at least one of the following: a remaining computing power resource of the terminal, a remaining storage of the terminal, and whether the terminal expects to be configured with an AI model or an AI function; and
the first information is used for the network device to determine whether to configure the AI model or the AI function, including at least one of the following:
if the remaining computing power resource and the remaining storage of the terminal support the terminal in accepting the configured AI model or AI function, and the terminal expects to be configured with the AI model or the AI function, the first information is used for indicating the network device to determine to configure the AI model or the AI function;
if the remaining computing power resource of the terminal does not support the terminal in accepting the configured AI model or AI function, the first information is used for indicating the network device to determine not to configure the AI model or the AI function;
if the remaining storage of the terminal does not support the terminal in accepting the configured AI model or AI function, the first information is used for indicating the network device to determine not to configure the AI model or the AI function; and if the terminal does not expect to be configured with the AI model or the AI function, the first information is used for indicating the network device to determine not to configure the AI model or the AI function.

Based on some embodiments of the second aspect, in some embodiments, the first information is used for indicating at least one of the following: a number of AI models or AI functions simultaneously supported by the terminal; and the first information is used for the network device to determine to configure the AI model or the AI function, and a number of configured AI models or AI functions is determined based on the number of AI models or AI functions simultaneously supported by the terminal.

Based on some embodiments of the second aspect, in some embodiments, before sending the first information, the method further includes:
receiving second information;
where the second information includes at least one of the following:
the second information is used for configuring the AI model or the AI function; and
the second information is used for indicating the terminal to send the first information.

Based on some embodiments of the second aspect, in some embodiments, after the first information is used for the network device to determine to configure the AI model or the AI function, the method further includes:
receiving third information, where the third information is used for configuring the AI model or the AI function.

Based on some embodiments of the second aspect, in some embodiments, after receiving the third information, the method further includes:
sending fourth information, where the fourth information is used for indicating that the terminal accepts the AI model or the AI function configured by the third information, or the fourth information is used for indicating that the terminal rejects the AI model or the AI function configured by the third information.

In a third aspect, an embodiment of the present disclosure proposes a communication method for a communication system. The method includes: determining, by a network device, first information, where the first information is used for indicating a state of a terminal for performing communication based on an AI model or an AI function, and the first information is used for the network device to determine whether to configure an AI model or AI function for the terminal; and determining, by the network device based on the first information, whether to configure the AI model or the AI function for the terminal.

In a fourth aspect, an embodiment of the present disclosure proposes a first communication apparatus. The first communication apparatus described above includes a processing module configured to: determine first information, where the first information is used for determining a state of a terminal for performing communication based on an AI model or an AI function; and determine, based on the first information, whether to configure the AI model or the AI function for the terminal.

In a fifth aspect, an embodiment of the present disclosure proposes a second communication apparatus. The second communication apparatus described above includes a sending module configured to send first information, where the first information is used for indicating a state of a terminal for performing communication based on an AI model or an AI function, and the first information is used for a network device to determine whether to configure the AI model or the AI function for the terminal.

In a sixth aspect, an embodiment of the present disclosure proposes a communication device. The communication device described above includes one or more processors, and one or more memories configured to store an instruction; where the processor is configured to invoke the instruction to cause the communication device described above to perform the method described in the first and second aspects, and the optional implementations in the first and second aspects. In a seventh aspect, an embodiment of the present disclosure proposes a communication system. The communication system described above includes a network device and a terminal, where the network device described above is configured to perform the method described in the optional implementations in the first and third aspects, and the terminal described above is configured to perform the method described in the optional implementations in the second and third aspects.

In an eighth aspect, an embodiment of the present disclosure proposes a storage medium, where the storage medium stores an instruction. The instruction described above, when run on a communication device, causes the communication device to perform the method described in the optional implementations in the first and third aspects, and the optional implementations in the second and third aspects.

In a ninth aspect, an embodiment of the present disclosure proposes a program product. The program product described above, when executed by a communication device, causes the communication device to perform the method described in the optional implementations in the first and third aspects, and the optional implementations in the second and third aspects.

In a tenth aspect, an embodiment of the present disclosure proposes a computer program. The computer program, when run on a computer, causes the computer to perform the method described in the optional implementations in the first and third aspects, and the optional implementations in the second and third aspects.

Understandably, the first communication apparatus, the second communication apparatus, the communication device, the communication system, the storage medium, the program product, and the computer program described above are all used for performing the method proposed in the embodiments of the present disclosure. Therefore, the beneficial effects they can achieve can be referenced from the beneficial effects in the corresponding method, and no further elaboration is provided here.

The embodiments of the present disclosure propose a communication method. In some embodiments, terms such as “communication method” and “information processing method” may be interchangeable, terms such as “communication device”, “information processing device”, and “communication apparatus” may be interchangeable, and terms such as “information processing system” and “communication system” may also be interchangeable. The embodiments of the present disclosure are not exhaustive, but merely illustrate a part of the embodiments and do not constitute specific limitations on the scope of protection of the present disclosure. In the absence of contradiction, each step in a certain embodiment may be implemented as an independent embodiment, and the steps may be arbitrarily combined. For example, a solution with a part of steps removed from a certain embodiment may also be implemented as an independent embodiment, and the order of the steps in a certain embodiment may be arbitrarily exchanged. In addition, the optional implementations in a certain embodiment may be arbitrarily combined. Additionally, the various embodiments may be arbitrarily combined. For example, a part of or all of the steps of different embodiments may be arbitrarily combined, and a certain embodiment may be arbitrarily combined with the optional implementations of other embodiments.

In various embodiments of the present disclosure, unless otherwise specified or logically conflicting, the terms and/or descriptions among the embodiments are consistent and may be mutually referenced. Technical features in different embodiments may be combined based on their inherent logical relationships to form new embodiments.

The terms used in the embodiments of the present disclosure are for the purpose of describing specific embodiments only, and are not intended to limit the present disclosure.

In the embodiments of the present disclosure, unless otherwise specified, elements expressed in singular forms, such as “a”, “an”, “the”, “above”, “said”, “aforementioned”, “this”, etc. may refer to “one and only one”, or may refer to “one or more” or “at least one” and the like. For example, when articles such as “a”, “an”, “the” in English are used in translation, the nouns following these articles may be understood as singular expression forms or plural expression forms.

In the embodiments of the present disclosure, “a plurality of” refers to two or more.

In some embodiments, terms such as “at least one of”, “one or more”, “a plurality of”, and “multiple” may be interchangeable.

In some embodiments, the reciting manners such as “at least one of A and B”, “A and/or B”, “in one situation A, in another situation B”, “in response to one situation A, in response to another situation B” may include the following technical solutions depending on the situation: in some embodiments, A (executing A independently of B); in some embodiments, B (executing B independently of A); in some embodiments, selectively executing A or B (executing A and B selectively); and in some embodiments, A and B (executing both A and B). When there are more branches such as A, B, C, etc., the solution is similar to the above.

In some embodiments, the reciting manners such as “A or B” may include the following technical solutions depending on the situation: in some embodiments, A (executing A independently of B); in some embodiments, B (executing B independently of A); in some embodiments, selectively executing A or B (executing A and B are selectively). When there are more branches such as A, B, C, etc., the solution is similar to the above.

The prefix words such as “first” and “second” in the embodiments of the present disclosure are only used to distinguish different described objects, and do not limit the position, order, priority, number, or content, etc. of the described objects. The description of the described objects may refer to the description in the claims or the context of the embodiments, and should not constitute unnecessary limitations due to the use of the prefix words. For example, if the described object is a “field”, then the ordinal number before the “field” in the “first field” and the “second field” does not limit the position or order between the “fields”, and “first” and “second” do not limit whether the “fields” they modify are in the same message, nor do they limit the sequential order of the “first field” and the “second field”. For another example, if the described object is a “level”, then the ordinal number before the “level” in the “first level” and the “second level” does not limit the priority between the “levels”. For another example, the number of the described objects is not limited by the ordinal number, and may be one or more. Taking the “first device” as an example, the number of “devices” may be one or more. Furthermore, the objects modified by different prefix words may be the same or different. For example, if the described object is a “device”, then the “first device” and the “second device” may be the same device or different devices, and may be of the same type or different types. For another example, if the described object is “information”, then the “first information” and the “second information” may be the same information or different information, and may be information of the same content or information of different contents.

In some embodiments, “comprising A”, “including A”, “used for indicating A”, and “carrying A” may be interpreted as directly carrying A, or may be interpreted as indirectly indicating A.

In some embodiments, terms such as “in response to . . . ”, “in response to determining . . . ”, “in the case of . . . ”, “when . . . ”, “at the time of . . . ”, “if . . . ”, “assuming . . . ”, etc. may be interchangeable. In some embodiments, terms such as “greater than”, “greater than or equal to”, “not less than”, “more than”, “more than or equal to”, “not smaller than”, “higher than”, “higher than or equal to”, “not lower than”, “above”, etc. may be interchangeable. Terms such as “less than”, “less than or equal to”, “not greater than”, “smaller than” “smaller than or equal to”, “not more than”, “lower than”, “lower than or equal to”, “not higher than”, “below”, etc. may be interchangeable. In some embodiments, devices and the like may be interpreted as physical or virtual, and their names are not limited to the names recited in the embodiments. Terms such as “apparatus”, “equipment”, “device”, “circuit”, “network element”, “node”, “function”, “unit”, “section”, “system”, “network”, “chip”, “chip system”, “entity”, “subject”, etc. may be interchangeable. In some embodiments, “network” may be interpreted as a device (e.g., an access network device, a core network device, etc.) included in the network.

In some embodiments, terms “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel”, “antenna panel”, “antenna array”, “cell”, “macro cell”, “small cell”, “femto cell”, “pico cell”, “sector”, “cell group”, “serving cell”, “carrier”, “component carrier”, “bandwidth part (BWP)”, etc. may be interchangeable.

In some embodiments, terms “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, etc. may be interchangeable.

In some embodiments, an access network device, a core network device, or a network device may be replaced with a terminal. For example, the various embodiments of the present disclosure may also be applied to a structure that replaces the communication between the access network device, the core network device, or the network device and the terminal with the communication among a plurality of terminals (e.g., device-to-device (D2D), vehicle-to-everything (V2X), etc.). In this case, the terminal may also be configured to have a structure with all of or a part of the functions of the access network device. In addition, terms such as “uplink” and “downlink” may also be replaced with the terms (e.g., “side”) corresponding to inter-terminal communication. For example, uplink channels, downlink channels, etc. may be replaced with side channels, and uplinks, downlinks, etc. may be replaced with sidelinks.

In some embodiments, the terminal may be replaced with an access network device, a core network device, or a network device. In this case, the access network device, the core network device, or the network device may have a structure that has all of or a part of the functions of the terminal.

In some embodiments, obtaining data, information, etc. may comply with the laws and regulations of the country where it is located.

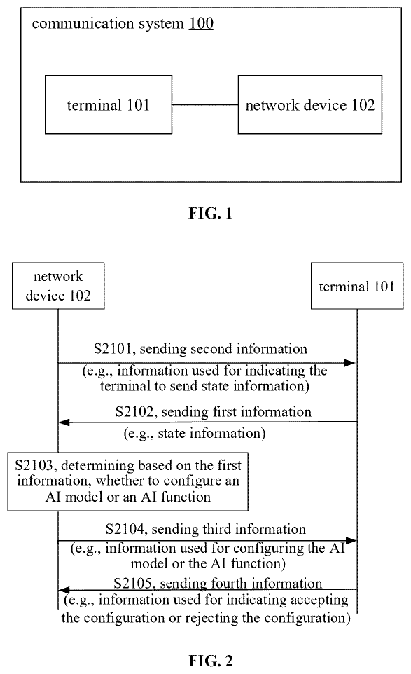

In some embodiments, data, information, etc. may be obtained after the user consent is obtained. In addition, each element, each row, or each column in the table of the embodiments of the present disclosure may be implemented as an independent embodiment, and the combination of any element, any row, or any column may also be implemented as an independent embodiment. FIG. 1 is a schematic architecture diagram of a communication system illustrated according to an embodiment of the present disclosure (a system diagram including only the relevant subjects of the invention point and their important opposite sides, with the number of subjects corresponding to the number of subjects involved in the invention point).

As shown in FIG. 1, the communication system 100 includes a terminal 101 and a network device 102.

In some embodiments, for example, the terminal 101 includes, but is not limited to, at least one of the following: a mobile phone, a wearable device, an IoT device, a vehicle with communication functions, a smart vehicle, a pad, a computer with wireless transceiving functions, a virtual reality (VR) terminal device 101, an augmented reality (AR) terminal device 101, a wireless terminal device 101 in industrial control, a wireless terminal device 101 in self-driving applications, a wireless terminal device 101 in remote medical surgery, a wireless terminal device 101 in the smart grid, a wireless terminal device 101 in transportation safety, a wireless terminal device 101 in the smart city, or a wireless terminal device 101 in smart homes. In some embodiments, the network device 102 may include at least one of an access network device and a core network device.

In some embodiments, for example, the terminal 101 includes, but is not limited to, at least one of the following: a mobile phone, a wearable device, an IoT device, a vehicle with communication functions, a smart vehicle, a pad, a computer with wireless transceiving functions, a virtual reality (VR) terminal device 101, an augmented reality (AR) terminal device 101, a wireless terminal device 101 in industrial control, a wireless terminal device 101 in self-driving applications, a wireless terminal device 101 in remote medical surgery, a wireless terminal device 101 in the smart grid, a wireless terminal device 101 in transportation safety, a wireless terminal device 101 in the smart city, or a wireless terminal device 101 in smart homes. In some embodiments, for example, the access network device is a node or a device that connects the terminal 101 to a wireless network. The access network device may include, but is not limited to, at least one of the following: an evolved node B (eNB), a next generation eNB (ng-eNB), a next generation node B (gNB), a node B (NB), a home node B (HNB), a home evolved node B (HeNB), a wireless backhaul device, a radio network controller (RNC), a base station controller (BSC), a base transceiver station (BTS), a base band unit (BBU), and a mobile switching center in a 5G communication system, a base station, an open RAN, a cloud RAN in a 6G communication system, a base station in other communication systems, and an access node in a wireless fidelity (WiFi) system.

In some embodiments, the technical solution in the present disclosure may be applicable to an Open RAN architecture. In this case, the interfaces between or within the access network devices involved in the embodiments of the present disclosure may become internal interfaces of the Open RAN. The procedures and information exchange between these internal interfaces may be implemented through software or programs.

In some embodiments, the access network device may be composed of a central unit (CU) and a distributed unit (DU). The CU may also be referred to as a control unit. The CU-DU structure may be used to separate the protocol layers of the access network device, with some protocol layer functions arranged in the CU for centra control, and a part of or all of the remaining protocol layer functions distributed in the DU, where the DU is centrally controlled by the CU, but is not limited to this.

In some embodiments, the core network device may be a device, including one or more network elements, or the core network device may be a plurality of devices or device groups, including one or more network elements. Alternatively, the core network device may be a physical entity. For example, the core network includes at least one of the following: an evolved packet core (EPC), a 5G core network (5GCN), and a next generation core (NGC).

Understandably, the communication system described in the embodiments of the present disclosure is for a clearer explanation of the technical solution of the embodiments of the present disclosure, but does not constitute a limitation on the technical solution proposed in the embodiments of the present disclosure. Those ordinary skilled in the art know that with the evolution of the system architecture and the emergence of new service scenarios, the technical solution proposed in the embodiments of the present disclosure is also applicable to similar technical problems.

The embodiments of the present disclosure described below may be applied to the communication system 100 shown in FIG. 1, or a part of the subjects in the communication system 100, but are not limited thereto. The subjects shown in FIG. 1 are illustrative only. The communication system may include all of or a part of the subjects shown in FIG. 1, or may include subjects other than those shown in FIG. 1. The number and form of each subject are arbitrary, and each subject may be physical or virtual. The connection relationships between the subjects are illustrative. The subjects may not be connected to each other or may be connected to each other. The connection may be in any way, either direct or indirect, wired or wireless. The embodiments of the present disclosure may be applied to the long term evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), future radio access (FRA), new-radio access technology (RAT), new radio (NR), new radio access (NX), future generation radio access (FX), global system for mobile communications (GSM (registered trademark)), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), public land mobile network (PLMN) network, device-to-device (D2D) system, machine-to-machine (M2M) system, Internet of Things (IOT) system, vehicle-to-everything (V2X) system, system utilizing other communication methods, and next generation system extended based on these, etc. Furthermore, a plurality of systems may be combined (for example, a combination of the LTE or the LTE-A with 5G) for application.

In recent years, AI technology has made continuous breakthroughs in a plurality of fields. The continuous development of intelligent voice, computer vision and other fields not only brings rich and colorful applications to intelligent terminals, but also has extensive applications in education, transportation, home furnishings, healthcare, retail, security and other fields, bringing convenience to people's lives and promoting industrial upgrading in various industries. The AI technology is also accelerating its cross penetration with other disciplinary fields, developing and integrating knowledge from different disciplines while providing new directions and methods for the development of different disciplines.

In some embodiments, a research project on the AI technology in the wireless air interface is established in the radio access network (RAN) to introduce the artificial intelligence technology into the wireless air interface and assist in improving the transmission technology of the wireless air interface. And currently, the application of the AI technology for communication processing in the wireless air interface is supported, including the training of AI models and the inference application of models.

In some embodiments, the relevant AI model or AI function may be defined for the AI application. The terminal 101 may report its supported AI model or AI function to the network device 102. The network device 102 may configure an AI model or an AI function for the terminal 101 based on the AI function or the AI model reported by the terminal 101. For example, the terminal 101 reports that it supports AI function 1, AI function 2, and AI function 3, and the network device 102 may configure AI function 2 for the terminal 101.

In some embodiments, the network device 102 configures an AI function or an AI model, and the terminal 101 may perform corresponding operations according to the configuration of the network device 102.

In some embodiments, when the terminal 101 needs to use a certain AI model or AI function for communication, the terminal 101 requires to consume a certain amount of the computing power resource and occupies a certain amount of the storage. However, the current state of the terminal 101 does not necessarily support the terminal 101 in using the AI model or the AI function for communication.

In some embodiments, an AI model or an AI function may include at least one of the following: an AI model, an AI function, an AI model and an AI function, which is not repeated in the following embodiments.

FIG. 2 is a schematic interaction diagram of a communication method illustrated according to an embodiment of the present disclosure. As shown in FIG. 2, the embodiment of the present disclosure relates to a communication method for a communication system 100. The method described above includes the following steps S2101 to S2105.

At step S2101, the network device 102 sends second information to the terminal 101.

In some embodiments, the terminal 101 receives the second information sent by the network device 102.

In some embodiments, the second information is used for indicating the terminal 101 to query state information of the terminal 101 for communication based on an AI model or an AI function. In some embodiments, the second information is used for indicating an AI model or an AI function configured by the network device 102. Optionally, the second information indicates, through an identification indicating the AI model or the AI function, the AI model or the AI function configured by the network device 102. Optionally, the identification may be an “ID”, or a “name”, etc.

In some embodiments, the second information is used for indicating the terminal 101 to send first information.

In some embodiments, the name of the second information is not limited, for example, the name of the second information is “indication information”, “configuration information”, “configuration signaling”, “query information”, “query signaling”, etc.

In some embodiments, the optional implementation of the first information may refer to the optional implementation of step S2102 in FIG. 2, which is not described here.

At step S2102, the terminal 101 sends the first information to the network device 102.

In some embodiments, the network device 102 receives the first information sent by the terminal 101.

In some embodiments, the first information is used for indicating the state of the terminal 101 for communication based on an AI model or an AI function.

In some embodiments, the state of the terminal 101 is used for indicating whether the terminal 101 is capable of performing communication based on an AI model or an AI function.

In some embodiments, the name of the first information is not limited, for example, the name of the first information is “indication information”, “feedback information”, “state information”, etc.

In some embodiments, the first information is used for indicating at least one of the following: a total storage supported by the terminal 101; a total computing power resource supported by the terminal 101; an AI model or an AI function supported by the terminal 101; a storage occupied by the AI model or the AI function supported by the terminal 101; a computing power resource occupied by the AI model or the AI function supported by the terminal 101; a maximum number of AI models or AI functions supported by the terminal 101; a number of AI models or AI functions simultaneously supported by the terminal 101; the terminal 101 accepting an AI model or an AI function configured by the network device 102; the terminal 101 rejecting the AI model or the AI function configured by the network device 102; a remaining computing power resource of the terminal 101; a remaining storage of the terminal 101; whether the terminal 101 expects to be configured with an AI model or an AI function; electric power amount information of the terminal 101; and a condition under which the terminal 101 allows configuration of an AI model or an AI function.

Optionally, the computing power resource of the terminal may also be referred to as the computing power of the terminal, the computing power capability of the terminal, etc.

Optionally, the storage of the terminal may also be referred to as the storage capability of the terminal, etc.

Optionally, the remaining computing power resource of the terminal 101 indicates the remaining computing power resource in the total computing power resource of the terminal 101, excluding the computing power resource occupied by the already configured AI model or AI function.

Optionally, the remaining storage of the terminal 101 indicates the remaining storage in the total storage of the terminal 101, excluding the storage occupied by the already configured AI model or AI function.

Optionally, the total storage supported by the terminal 101 may also be understood as the storage capability of the terminal 101, etc.

Optionally, the total computing power resource supported by the terminal 101 may also be understood as the total computing power supported by the terminal 101, the computing power capability of the terminal 101, etc.

Optionally, “expects to be configured” may be interpreted as the terminal 101 expecting to receive a configured AI model or AI function, or may be interpreted as performing subsequent processing on the AI model or AI function after receiving the configured AI model or AI function. “Does not expect to be configured” may be interpreted as not expecting to receive a configured AI model or AI function, or may be interpreted as expecting to receive but not expecting to perform subsequent processing on the AI model or AI function.

In some embodiments, the first information is used for indicating the total storage supported by the terminal 101. Optionally, the total storage supported by the terminal 101 indicates the resource that the terminal 101 is capable of storing an AI model or an AI function.

In some embodiments, the first information is used for indicating the total computing power resource supported by the terminal 101. Optionally, the total computing power resource supported by the terminal 101 indicates the resource that terminal 101 is capable of processing an AI model or an AI function.

In some embodiments, the first information is used for indicating an AI model or an AI function supported by the terminal 101. Optionally, the first information may include the name, identification, etc. of the AI model or the AI function supported by the terminal 101.

In some embodiments, the first information is used for indicating a storage occupied by the AI model or the AI function supported by the terminal 101. Optionally, the terminal 101 supports one or more AI models or AI functions, and the first information is used for indicating the storage occupied by each AI model or AI function of the one or more AI models or AI functions.

In some embodiments, the first information is used for indicating a computing power resource occupied by the AI model or the AI function supported by the terminal 101. Optionally, the terminal 101 supports one or more AI models or AI functions, and the first information is used for indicating the computing power resource occupied by each AI model or AI function of the one or more AI models or AI functions.

In some embodiments, the first information is used for indicating the number of AI models or AI functions simultaneously supported by the terminal 101. Optionally, the terminal 101 supports one or more AI models or AI functions, and the number of AI models or AI functions based on which the terminal 101 is capable of performing communication at the same time point may not be the same as the number of AI models or AI functions supported by the terminal 101.

Optionally, the terminal 101 is currently configured with a plurality of AI models or AI functions. The terminal 101 determines that it cannot perform communication based on the plurality of AI models or AI functions simultaneously, and determines the number of AI models or AI functions simultaneously supported by the terminal 101.

In some embodiments, the first information is used for indicating that the terminal 101 accepts an AI model or an AI function configured by the network device 102, or the first information is used for indicating that the terminal 101 rejects the AI model or the AI function configured by the network device 102. Optionally, whether the terminal 101 accepts the AI model or the AI function configured by the network device 102 is determined by the terminal 101.

For example, the terminal 101 determines, based on the remaining storage, the remaining computing power resource, and whether the terminal 101 expects to be configured with an AI model or an AI function, whether to accept the AI model or the AI function configured by the network device 102. For example, if the remaining storage of the terminal 101 does not support the terminal 101 in accepting a new AI model or AI function, the terminal 101 determines that the terminal 101 cannot accept the AI model or the AI function configured by the network device 102, that is, the first information is used for indicating that the terminal 101 rejects the AI model or the AI function configured by the network device 102. For example, if the remaining storage and the remaining computing power resource of the terminal 101 are capable of supporting the terminal 101 in accepting a new AI model or AI function, then the terminal 101 determines that the terminal 101 can accept the AI model or the AI function configured by the network device 102, that is, the first information is used for indicating that the terminal 101 accepts the AI model or the AI function configured by the network device 102.

In some embodiments, the first information is used for indicating electric power amount information of the terminal 101. Optionally, the electric power amount information may include the amount of the remaining electric power of the terminal.

In some embodiments, the first information is used for indicating a condition under which the terminal 101 allows configuration of an AI model or an AI function. Optionally, the terminal 101 sends to the network device 102 the condition under which the terminal 101 allows configuration of an AI model or an AI function.

Optionally, the condition under which the terminal 101 allows configuration of an AI model or an AI function may include at least one of the following: a storage under which the terminal 101 allows configuration of an AI model or an AI function, a computing power resource under which the terminal 101 allows configuration of an AI model or an AI function, and an amount of electric power under which the terminal 101 allows configuration of an AI model or an AI function, etc. The embodiment of the present disclosure does not make limitations here.

In some embodiments, the terminal 101 receives the second information sent by the network device 102, where the second information is used for indicating the AI model or the AI function configured by the network device 102. Optionally, the first information sent by the terminal 101 to the network device 102 is used for indicating that the terminal 101 accepts the AI model or the AI function configured by the network device 102, or indicating that the terminal 101 rejects the AI model or the AI function configured by the network device 102.

In some embodiments, the terminal 101 receives the second information sent by the network device 102, where the second information is used for indicating the terminal 101 to send the first information. Optionally, the first information sent by the terminal 101 to the network device 102 is used for indicating the remaining computing power resource of the terminal 101, the remaining storage of the terminal 101, and whether the terminal 101 expects to be configured with an AI model or AI function.

In some embodiments, the terminal 101 receives the second information sent by the network device 101, where the second information is used for indicating the AI model or the AI function configured by the network device 102. Optionally, the first information sent by the terminal 101 to the network device 102 is used for indicating the number of AI models or AI functions simultaneously supported by the terminal 101.

In some embodiments, step S2101 is an optional step.

In some embodiments, the terminal 101 does not receive the second information sent by the network device 102, and the first information is used for indicating at least one of the following: the total storage supported by the terminal 101, the total computing power resource supported by the terminal 101, the AI model or the AI function supported by the terminal 101, the storage occupied by the AI model or the AI function supported by the terminal 101, the computing power resource occupied by the AI model or the AI function supported by the terminal 101, the maximum number of AI models or AI functions supported by the terminal 101, the electric power amount information of the terminal, and the condition under which the terminal allows configuration of an AI model or an AI function.

At step S2103, the network device 102 determines, based on the first information, whether to configure an AI model or an AI function.

In some embodiments, the first information is used for indicating at least one of the following: a total storage supported by the terminal 101, a total computing power resource supported by the terminal 101, an AI model or an AI function supported by the terminal 101, a storage occupied by the AI model or the AI function supported by the terminal 101, and a computing power resource occupied by the AI model or the AI function supported by the terminal 101.

In some embodiments, the network device 102 determines the remaining storage and the remining computing power resource of the terminal 101 based on the first information.

Optionally, the network device 102 determines the remaining storage of the terminal 101 based on the total storage supported by the terminal 101 and the storage occupied by the AI model or the AI function currently configured for the terminal 101. Optionally, the network device 102 can know the AI model or the AI function that the terminal 101 has currently been configured with. Optionally, the storage occupied by the AI model or the AI function currently configured for the terminal 101 is determined based on the storage occupied by the AI model or the AI function supported by the terminal 101.

It should be understood that the AI model or the AI function currently configured for the terminal 101 is the AI model or the AI function supported by the terminal 101.

Optionally, the network device 102 determines the remaining computing power resource of the terminal 101 based on the total computing power resource supported by the terminal 101 and the AI model or the AI function currently configured for the terminal 101. Optionally, the network device 102 can know the AI model or the AI function that the terminal 101 has currently been configured with. Optionally, the computing power resource occupied by the AI model or the AI function currently configured for the terminal 101 is determined based on the computing power resource occupied by the AI model or the AI function supported by the terminal 101.

In some embodiments, the network device 102 determines, based on the remaining storage and the remaining computing power resource of the terminal 101, whether to configure an AI model or an AI function.

In some embodiments, determining, by the network device 102 based on the remaining storage and the remaining computing power resource of the terminal 101, whether to configure an AI model or an AI function includes at least one of the following:
if the remaining storage and the remaining computing power resource of the terminal 101 support the terminal 101 in receiving the configured AI model or AI function, determining by the network device 102 to configure the AI model or the AI function; and
if the remaining storage and the remaining computing power resource of the terminal 101 do not support the terminal 101 in receiving the configured AI model or AI function, determining by the network device 102 not to configure the AI model or the AI function.

Optionally, the remaining storage and the remaining computing power resource of the terminal 101 support the terminal 101 in receiving the configured AI model or AI function. Optionally, if the remaining storage of the terminal 101 is greater than or equal to the storage occupied by the AI model or the AI function supported by the terminal 101, and the remaining computing power resource of the terminal 101 is greater than or equal to the computing power resource occupied by the AI model or the AI function supported by the terminal 101, then the network device 102 determines that the terminal 101 is capable of receiving a new configured AI model or AI function, and thus determines to configure the AI model or the AI function.

Optionally, the remaining storage and the remaining computing power resource of the terminal 101 do not support the terminal 101 in accepting the configured AI model or AI function.

Optionally, if the remaining storage of the terminal 101 is less than the storage occupied by the AI model or the AI function supported by the terminal 101, and the remaining computing power resource of the terminal 101 is less than the computing power resource occupied by the AI model or the AI function supported by the terminal 101, then the network device 102 determines that the terminal 101 is not capable of accepting a new configured AI model or AI function, and thus determines not to configure the AI model or the AI function.

In some embodiments, the remaining storage and the remaining computing power resource of the terminal 101 support the terminal 101 in receiving the configured AI model or AI function, and the network device 102 determines to configure the AI model or the AI function.

In some embodiments, the remaining storage and the remaining computing power resource of the terminal 101 are not capable of supporting the terminal 101 in receiving the configured AI model or AI function, and the network device 102 determines not to configure the AI model or the AI function.

In some embodiments, the remaining storage and the remaining computing power resource of the terminal 101 support the terminal 101 in receiving the configured AI model or AI function, and the network device 102 determines to configure the AI model or the AI function. The remaining storage and the remaining computing power resource of the terminal 101 are not capable of supporting the terminal 101 in receiving the configured AI model or AI function, and the network device 102 determines not to configure the AI model or the AI function.

In some embodiments, the first information is used for indicating the maximum number of AI models or AI functions supported by the terminal 101.

Optionally, the network device 102 determines, based on the maximum number of AI models or AI functions supported by the terminal and the number of AI models or AI functions currently configured for the terminal, whether to configure an AI model or an AI function.

In some embodiments, determining, by the network device 102 based on the first information, whether to configure an AI model or an AI function includes at least one of the following:
if the maximum number of AI models or AI functions supported by the terminal 101 is greater than the number of AI models or AI functions currently configured for the terminal for performing communication, determining by the network device 102 to configure the AI model or the AI function; and
if the maximum number of AI models or AI functions supported by the terminal 101 is less than or equal to the number of AI models or AI functions currently configured for the terminal for performing communication, determining by the network device 102 not to configure the AI model or the AI function.

In some embodiments, if the maximum number of AI models or AI functions supported by the terminal 101 is greater than the number of AI models or AI functions currently configured for the terminal for performing communication, the network device 102 determines to configure the AI model or the AI function.

In some embodiments, if the maximum number of AI models or AI functions supported by the terminal 101 is less than or equal to the number of AI models or AI functions currently configured for the terminal for performing communication, the network device 102 determines not to configure the AI model or the AI function.

In some embodiments, the maximum number of AI models or AI functions supported by the terminal 101 is greater than the number of AI models or AI functions currently configured for the terminal for performing communication, and the network device 102 determines to configure the AI model or the AI function; and the maximum number of AI models or AI functions supported by the terminal 101 is less than or equal to the number of AI models or AI functions currently configured for the terminal for performing communication, and the network device 102 determines not to configure the AI model or the AI function.

In some embodiments, the first information is used for indicating the number of AI models or AI functions simultaneously supported by the terminal 101.

In some embodiments, determining, by the network device 102 based on the first information, whether to configure an AI model or an AI function includes:
determining, by the network device 102 based on the number of AI models or AI functions simultaneously supported by the terminal 101, to configure the AI model or the AI function.

Optionally, the number of AI models or AI functions configured by the network device 102 is determined based on the number of AI models or AI functions simultaneously supported by the terminal 101. For example, if the terminal 101 supports three AI models or AI functions simultaneously, the network device 102 determines that the number of configured AI models or AI functions is less than or equal to three.

In some embodiments, the first information is used for indicating that the terminal 101 accepts an AI model or an AI function configured by the network device 102, or indicating that the terminal 101 rejects the AI model or the AI function configured by the network device 102.

In some embodiments, determining, by the network device 102 based on the first information, whether to configure an AI model or an AI function includes at least one of the following: if the first information is used for indicating that the terminal 101 accepts the AI model or the AI function configured by the network device 102, determining by the network device 102 to configure the AI model or the AI function; and
if the first information is used for indicating that the terminal 101 rejects the AI model or the AI function configured by the network device 102, determining by the network device 102 not to configure the AI model or the AI function.

In some embodiments, the first information is used for indicating that the terminal 101 accepts the AI model or the AI function configured by the network device 102, and the network device 102 determines to configure the AI model or the AI function.

In some embodiments, the first information is used for indicating that the terminal 101 rejects the AI model or the AI function configured by the network device 102, and the network device 102 determines not to configure the AI model or the AI function.

In some embodiments, the first information is used for indicating that the terminal 101 accepts the AI model or the AI function configured by the network device 102, and the network device 102 determines to configure the AI model or the AI function; and the first information is used for indicating that the terminal 101 rejects the AI model or the AI function configured by the network device 102, and the network device 102 determines not to configure the AI model or the AI function.

In some embodiments, the first information is used for indicating at least one of the following: a remaining computing power resource of the terminal 101, a remaining storage of the terminal 101, and whether the terminal 101 expects to be configured with an AI model or an AI function. In some embodiments, determining, by the network device 102 based on the first information, whether to configure an AI model or an AI function includes at least one of the following:
if the remaining computing power resource and the remaining storage of the terminal 101 support the terminal 101 in accepting the configured AI model or AI function, and the terminal 101 expects to be configured with the AI model or the AI function, determining by the network device 102 to configure the AI model or the AI function;
if the remaining computing power resource of the terminal 101 does not support the terminal 101 in accepting the configured AI model or AI function, determining by the network device 102 not to configure the AI model or the AI function;
if the remaining storage of the terminal 101 does not support the terminal 101 in accepting the configured AI model or AI function, determining by the network device 102 not to configure the AI model or the AI function; and
if the terminal 101 does not expect to be configured with the AI model or the AI function, determining by the network device 102 not to configure the AI model or the AI function.

In some embodiments, the remaining computing power resource and the remaining storage of the terminal 101 support the terminal 101 in accepting the configured AI model or AI function, the terminal 101 expects to be configured with the AI model or the AI function, and the network device 102 determines to configure the AI model or the AI function.

In some embodiments, the remaining computing power resource of the terminal 101 does not support the terminal 101 in accepting the configured AI model or AI function, and the network device 102 determines not to configure the AI model or the AI function.

In some embodiments, the remaining storage of the terminal 101 does not support the terminal 101 in accepting the configured AI model or AI function, and the network device 102 determines not to configure the AI model or the AI function.

In some embodiments, the terminal 101 does not expect to be configured with the AI model or the AI function, and the network device 102 determines not to configure the AI model or the AI function.

In some embodiments, the remaining computing power resource and the remaining storage of the terminal 101 support the terminal 101 in accepting the configured AI model or AI function, the terminal 101 expects to be configured with the AI model or the AI function, and the network device 102 determines to configure the AI model or the AI function; the remaining computing power resource of the terminal 101 does not support the terminal 101 in accepting the configured AI model or AI function, and the network device 102 determines not to configure the AI model or the AI function; the remaining storage of the terminal 101 does not support the terminal 101 in accepting the configured AI model or AI function, and the network device 102 determines not to configure the AI model or the AI function; and the terminal 101 does not expect to be configured with the AI model or the AI function, and the network device 102 determines not to configure the AI model or the AI function.

In some embodiments, the first information is used for indicating electric power amount information of the terminal 101.

In some embodiments, determining, by the network device 102 based on the first information, whether to configure an AI model or an AI function includes at least one of the following:
if the electric power amount information of the terminal 101 does not support the terminal 101 in accepting the configured AI model or AI function, determining by the network device 102 not to configure the AI model or the AI function; and
if the electric power amount information of the terminal 101 supports the terminal 101 in accepting the configured AI model or AI function, determining by the network device 102 to configure the AI model or the AI function.

In some embodiments, the electric power amount information of the terminal 101 does not support the terminal 101 in accepting the configured AI model or AI function, and the network device 102 determines not to configure the AI model or the AI function.

In some embodiments, the electric power amount information of the terminal 101 supports the terminal 101 in accepting the configured AI model or AI function, and the network device 102 determines to configure the AI model or the AI function.

In some embodiments, the electric power amount information of the terminal 101 does not support the terminal 101 in accepting the configured AI model or AI function, and the network device 102 determines not to configure the AI model or the AI function; and the electric power amount information of the terminal 101 supports the terminal 101 in accepting the configured AI model or AI function, and the network device 102 determines to configure the AI model or the AI function.

In some embodiments, the first information is used for indicating a condition under which the terminal 101 allows configuration of an AI model or an AI function.

Optionally, the condition under which the terminal 101 allows configuration of an AI model or an AI function is the computing power resource under which the terminal 101 allows configuration of an AI model or an AI function.

Optionally, determining, by the network device 102 based on the first information, whether to configure an AI model or an AI function includes at least one of the following:
if the network device 101 determines, based on the current computing power resource of the terminal 101, that the computing power resource under which the terminal 101 allows configuration of an AI model or an AI function is satisfied, determining by the network device 101 to configure the AI model or the AI function; and
if the network device 101 determines, based on the current computing power resource of the terminal 101, that the computing power resource under which the terminal 101 allows configuration of an AI model or an AI function is not satisfied, determining by the network device 101 not to configure the AI model or the AI function.

Optionally, the condition under which the terminal 101 allows configuration of an AI model or an AI function is a storage under which the terminal 101 allows configuration of an AI model or an AI function.

Optionally, determining, by the network device 102 based on the first information, whether to configure an AI model or an AI function includes:
if the network device 101 determines, based on the current storage of the terminal 101, that the storage under which the terminal 101 allows configuration of an AI model or an AI function is satisfied, determining by the network device 101 to configure the AI model or the AI function; and
if the network device 101 determines, based on the current storage of the terminal 101, that the storage under which the terminal 101 allows configuration of an AI model or an AI function is not satisfied, determining by the network device 101 not to configure the AI model or the AI function.

At step S2104, the network device 102 sends third information to the terminal 101.

In some embodiments, the terminal 101 receives the third information sent by the network device 102.

In some embodiments, the third information is used for the network device 102 to configure the AI model or the AI function.

Optionally, when the network device 102 sends the second information to the terminal 101, and the second information is used for indicating the AI model or the AI function configured by the network device 102, the AI model or the AI function configured by the third information and the AI model or the AI function configured by the second information are different.

Optionally, the second information is used for indicating the AI model or the AI function configured by the network device 102. The terminal 101 determines, based on the second information, whether to accept the AI model or the AI function configured by the network device 102. If the terminal determines to accept the AI model or the AI function configured by the network device 102, the network device 102 may send the third information to configure a new AI model or AI function. Optionally, the new AI model or AI function configured by the third information may be different from the AI model or the AI function configured by the second information.

For example, if the second information is used for configuring AI model 1, and the terminal 101 determines that it can accept AI model 1, then the network device 102, based on the message that the terminal 101 determines that it can accept AI model 1, continues to configure AI model 2. If the terminal 101 determines that it cannot accept AI model 1, the network device 102, based on the message that the terminal 101 determines that it cannot accept AI model 1, does not continue to configure a new AI model.

In some embodiments, the name of the third information is not limited, for example, the name of the third information is “indication information”, “configuration information”, “configuration signaling”, etc.

In some embodiments, the AI model or the AI function configured by the network device 102 is the AI model or the AI function supported by the terminal 101.

In some embodiments, the terminal 101 is capable of performing communication based on the AI model or the AI function configured by the network device 102.

At step S2105, the terminal 101 sends fourth information to the network device 102.

In some embodiments, the network device 102 receives the fourth information sent by the terminal 101.

In some embodiments, the fourth information is used for indicating that the terminal 101 accepts the AI model or the AI function configured by the third information.

In some embodiments, the fourth information is used for indicating that the terminal 101 rejects the AI model or the AI function configured by the third information.

In some embodiments, the name of the fourth information is not limited, for example, the name of the fourth information is “indication information”, “feedback information”, etc.

In some embodiments, the terminal 101 determines the fourth information based on the current state of the terminal 101.

In some embodiments, the current state of the terminal 101 may include the current amount of the electric power of the terminal 101. Optionally, if current amount of the electric power of the terminal 101 is less than the electric power amount threshold, the fourth information is used for rejecting the AI model or the AI function configured by the network device 102. Optionally, if current amount of the electric power of the terminal 101 is greater than the electric power amount threshold, the fourth information is used for accepting the AI model or the AI function configured by the network device 102.

In some embodiments, terms such as “send”, “emit”, “report”, “issue”, “transmit”, “transmit bidirectionally”, “send and/or receive” may be interchangeable.

In some embodiments, “obtain”, “acquire”, “get”, “receive”, “transmit” “transmit bidirectionally”, and “send and/or receive”, etc. may be interchangeable, and may be interpreted as various meanings, such as receiving from another subject, obtaining from a protocol, obtaining from an upper layer, obtaining through self-processing, and autonomous implementation, etc.

In some embodiments, the names of information, etc., are not limited to those recited in the embodiments. Terms such as “information”, “message”, “signal”, “signaling”, “report”, “configuration”, “indication”, “instruction”, “command”, “channel”, “parameter”, “domain”, “field”, “symbol”, “codebook”, “codeword”, “codepoint”, “bit”, “data”, “program”, and “chip”, etc. may be interchangeable.

The communication method involved in the embodiments of the present disclosure may include at least one of steps S2102 to S2105. For example, step S2102 may be implemented as an independent embodiment, step S2103 may be implemented as an independent embodiment, steps S2102+step S2103 may be implemented as an independent embodiment, step S2102+step 2103+step S2104 may be implemented as an independent embodiment, step S 2101+step 2102+step S2103 may be implemented as an independent embodiment, step S 2101+step 2102+step S 2103 +step S2104 may be implemented as an independent embodiment, which is not limited thereto.

In some embodiments, step S2101, step S2103, step S2104, and step S2105 are optional, and one or more of these steps may be omitted or replaced in different embodiments.

In some embodiments, step S2101, step S2102, step S2104, and step S2105 are optional, and one or more of these steps may be omitted or replaced in different embodiments.

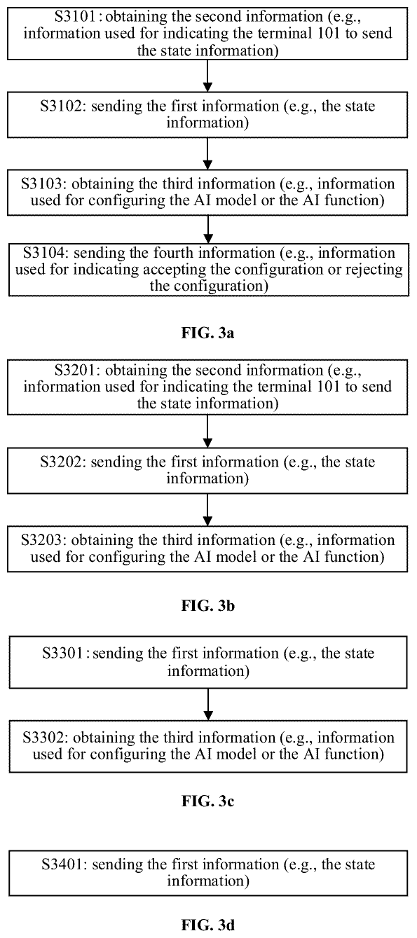

FIG. 3a is a flowchart of a communication method illustrated according to an embodiment of the present disclosure. As shown in FIG. 3a, the embodiment of the present disclosure relates to a communication method performed by the terminal 101. The method described above includes the following steps S3101 to S3104.

At step S3101, the second information is obtained.

The optional implementation of step S3101 may refer to the optional implementation of step S2101 in FIG. 2, and other related parts in the embodiments involved in FIG. 2, which will not be repeated here.

In some embodiments, the terminal 101 receives the second information from the network device 102, but may also receive the second information from other subjects.

In some embodiments, the terminal 101 obtains the second information specified by the protocol.

In some embodiments, the terminal 101 obtains the second information from the upper layer(s).

In some embodiments, the terminal 101 performs processing to obtain the second information.

In some embodiments, step S3101 is omitted, and the terminal 101 autonomously determines the second information.

At step S3102, the first information is sent.

The optional implementation of step S3102 may refer to the optional implementation of step S2102 in FIG. 2, and other related parts in the embodiments involved in FIG. 2, which will not be repeated here.

At step S3103, the third information is obtained.

The optional implementation of step S3103 may refer to the optional implementation of step S2104 in FIG. 2, and other related parts in the embodiments involved in FIG. 2, which will not be repeated here.

In some embodiments, the terminal 101 receives the third information from the network device 102, but may also receive the third information from other subjects.

In some embodiments, the terminal 101 obtains the third information specified by the protocol.

In some embodiments, the terminal 101 obtains the third information from the upper layer(s).

In some embodiments, the terminal 101 performs processing to obtain the third information.

In some embodiments, step S3103 is omitted, and the terminal 101 autonomously determines the third information.

At step S3104, the fourth information is sent.

The optional implementation of step S3104 may refer to the optional implementation of step S2105 in FIG. 2, and other related parts in the embodiments involved in FIG. 2, which will not be repeated here.

The communication method involved in the embodiments of the present disclosure may include at least one of steps S3101 to S3104. For example, step S3102 may be implemented as an independent embodiment, step S3103 may be implemented as an independent embodiment, step S3101+step S3102 may be implemented as an independent embodiment, step S3101+step S3103 may be implemented as an independent embodiment, step S3103+step S3104 may be implemented as an independent embodiment, and step S3101+step S3102+step S3103 may be implemented as an independent embodiment, which is not limited thereto.

In some embodiments, step S3101 is optional, and one or more of these steps may be omitted or replaced in different embodiments.

In some embodiments, step S3103 is optional, and one or more of these steps may be omitted or replaced in different embodiments.

In some embodiments, step S3104 is optional, and one or more of these steps may be omitted or replaced in different embodiments.

FIG. 3b is a flowchart of a communication method illustrated according to an embodiment of the present disclosure. As shown in FIG. 3b, the embodiment of the present disclosure relates to a communication method performed by the terminal 101. The method described above includes the following steps S3201 to S3203.

At step S3201, the second information is obtained.

The optional implementation of step S3201 may refer to the optional implementation of step S2101 in FIG. 2, and other related parts in the embodiments involved in FIG. 2. In an optional embodiment, the optional implementation of step S3201 may refer to the optional implementation of step S3101 in FIG. 3a, and other related parts in the embodiments involved in FIG. 3a, which will not be repeated here.

In some embodiments, the second information is used for configuring the AI model or the AI function.

In some embodiments, the second information is used for indicating the terminal 101 to determine the first information.

At step S3202, the first information is sent.

The optional implementation of step S3202 may refer to the optional implementation of step S2102 in FIG. 2, and other related parts in the embodiments involved in FIG. 2, which will not be repeated here.

In some embodiments, the first information is used for indicating at least one of the following: a remaining computing power resource of the terminal 101; a remaining storage of the terminal 101; whether the terminal 101 expects to be configured with an AI model or an AI function; the terminal 101 accepting an AI model or an AI function configured by the network device 102; and the terminal 101 rejecting the AI model or the AI function configured by the network device 102. In some embodiments, the second information is used for indicating the configured AI model or AI function. Optionally, the first information is used for indicating at least one of the following: the terminal 101 accepting an AI model or an AI function configured by the network device 102; and the terminal 101 rejecting the AI model or the AI function configured by the network device 102.

In some embodiments, the second information is used for indicating the terminal 101 to determine the first information. The first information is used for indicating at least one of the following: the remaining computing power resource of the terminal 101; the remaining storage of the terminal 101; and whether the terminal 101 expects to be configured with an AI model or an AI function.

At step S3203, the third information is obtained.

The optional implementation of step S3203 may refer to the optional implementation of step S2104 in FIG. 2, and other related parts in the embodiments involved in FIG. 2, which will not be repeated here. In an optional embodiment, the optional implementation of step S3203 may refer to step S3103 in FIG. 3a, and other related parts in the embodiments involved in in FIG. 3a, which will not be repeated here.

The communication method involved in the embodiments of the present disclosure may include at least one of steps S3201 to S3203. For example, step S3202 may be implemented as an independent embodiment, step S3201+step S3202 may be implemented as an independent embodiment, and step S3201+step S3202+step S3203 may be implemented as an independent embodiment, which is not limited thereto.

In some embodiments, step S3203 is optional, and one or more of these steps may be omitted or replaced in different embodiments.

The AI model or the AI function configured by the network device 102.

The communication method involved in the embodiments of the present disclosure may include at least one of steps S3201 to S3203. For example, step S3201 may be implemented as an independent embodiment, and steps S3201+step S3202 may be implemented as an independent embodiment, which is not limited thereto.

In some embodiments, step S3203 is optional, and one or more of these steps may be omitted or replaced in different embodiments.

FIG. 3c is a flowchart of a communication method illustrated according to an embodiment of the present disclosure. As shown in FIG. 3c, the embodiment of the present disclosure relates to a communication method performed by the terminal 101. The method described above includes the following steps S3301 to S3302.

[symbol] step S3301, the first information is sent.

The optional implementation of step S3301 may refer to the optional implementation of step S2102 in FIG. 2, and other related parts in the embodiments involved in FIG. 2, which will not be repeated here. In an optional embodiment, the optional implementation of step S3301 may refer to step S3102 in FIG. 3a, and other related parts in the embodiments involved in FIG. 3a, which will not be repeated here.

In some embodiments, the first information is used for indicating at least one of the following: a total storage supported by the terminal 101; a total computing power resource supported by the terminal 101; an AI model or an AI function supported by the terminal 101; a storage occupied by the AI model or the AI function supported by the terminal 101; and a computing power resource occupied by the AI model or the AI function supported by the terminal 101; a maximum number of AI models or AI functions supported by the terminal 101; and a number of AI models or AI functions simultaneously supported by the terminal 101.

At step S3302, the third information is obtained.

The optional implementation of step S3302 may refer to the optional implementation of step S2104 in FIG. 2, and other related parts in the embodiments involved in FIG. 2, which will not be repeated here. In an optional embodiment, the optional implementation of step S3302 may refer to step S3103 of FIG. 3a, and other related parts in the embodiments involved in FIG. 3a, which will not be repeated here.

The communication method involved in the embodiments of the present disclosure may include at least one of steps S3301 to S3302. For example, step S3301 may be implemented as an independent embodiment, which will not be repeated here.

In some embodiments, step S3302 is optional, and one or more of these steps may be omitted or replaced in different embodiments.

FIG. 3d is a flowchart of a communication method illustrated according to an embodiment of the present disclosure. As shown in FIG. 3d, the embodiment of the present disclosure relates to a communication method performed by the terminal 101. The method described above includes the following step S3401.

At step S3401, the first information is sent.

The optional implementation of step S3401 may refer to the optional implementation of step S2102 in FIG. 2, and other related parts in the embodiments involved in FIG. 2, which will not be repeated here. In an optional embodiment, the optional implementation of step S3401 may refer to step S3102 in FIG. 3a, and other related parts in the embodiments involved in FIG. 3a, which will not be repeated here.

In some embodiments, the first information is used for indicating at least one of the following: a total storage supported by the terminal 101; a total computing power resource supported by the terminal 101; an AI model or an AI function supported by the terminal 101; a storage occupied by the AI model or the AI function supported by the terminal 101; and a computing power resource occupied by the AI model or the AI function supported by the terminal 101.

The first information is used for the network device 102 to determine the remaining storage and the remaining computing power resource of the terminal 101, and is used for the network device 102 to determine, based on the remaining storage and computing power resources of the terminal 101, whether to configure an AI model or AI function.

In some embodiments, the first information is used for the network device 102 to determine the remaining storage and the computing power resource of the terminal 101, and is used for the network device 102 to determine, based on the remaining storage and the remaining computing power resource of the terminal 101, whether to configure an AI model or an AI function, including at least one of the following:
if the remaining storage and the remaining computing power resource of the terminal 101 support the terminal 101 in accepting the configured AI model or AI function, the first information is used for the network device 102 to determine to configure the AI model or the AI function; and if the remaining storage and the remaining computing power resource of the terminal 101 do not support the terminal 101 in accepting the configured AI model or AI function, the first information is used for the network device 102 to determine not to configure the AI model or the AI function.

In some embodiments, the first information is used for indicating the maximum number of AI models or AI functions supported by the terminal 101.

The first information is used for the network device 102 to determine whether to configure the AI model or the AI function, including at least one of the following:
if the maximum number of AI models or AI functions supported by the terminal 101 is less than or equal to the number of AI models or AI functions currently configured for the terminal 101 for performing communication, the first information is used for the network device 102 to determine not to configure the AI model or the AI function; and
if the maximum number of AI models or AI functions supported by the terminal 101 is greater than the number of AI models or AI functions currently configured for the terminal 101 for performing communication, the first information is used for the network device 102 to determine to configure the AI model or the AI function for the terminal 101.

In some embodiments, the first information is used for indicating that the terminal 101 accepts the AI model or the AI function configured by the network device 102, or indicating that the terminal 101 rejects the AI model or the AI function configured by the network device 102.

The first information is used for the network device 102 to determine whether to configure the AI model or the AI function, including at least one of the following:
if the first information is used for indicating that the terminal 101 accepts the AI model or the AI function configured by the network device 102, the first information is used for indicating the network device 102 to determine not to configure the AI model or the AI function; and
if the first information is used for indicating that the terminal 101 rejects the AI model or the AI function configured by the network device 102, the first information is used for indicating the network device 102 to determine not to configure the AI model or the AI function.

In some embodiments, the first information is used for indicating at least one of the following: a remaining computing power resource of the terminal 101, a remaining storage of the terminal 101, and whether the terminal expects to be configured with an AI model or an AI function.

The first information is used for the network device 102 to determine whether to configure the AI model or the AI function, including at least one of the following:
if the remaining computing power resource and the remaining storage of the terminal 101 support the terminal 101 in accepting the configured AI model or AI function, and the terminal 101 expects to be configured with the AI model or the AI function, the first information is used for indicating the network device 102 to determine to configure the AI model or the AI function; if the remaining computing power resource of the terminal 101 does not support the terminal 101 in accepting the configured AI model or AI function, the first information is used for indicating the network device 102 to determine not to configure the AI model or the AI function;
if the remaining storage of the terminal 101 does not support the terminal 101 in accepting the configured AI model or AI function, the first information is used for indicating the network device 102 to determine not to configure the AI model or the AI function; and
if the terminal 101 does not expect to be configured with the AI model or the AI function, the first information is used for indicating the network device 102 to determine not to configure the AI model or the AI function.

In some embodiments, the first information is used for indicating at least one of the following: the number of AI models or AI functions simultaneously supported by the terminal 101; the first information is used for the network device 102 to determine to configure the AI model or the AI function, and the number of configured AI models or AI functions is determined based on the number of AI models or AI functions simultaneously supported by the terminal 101.

In some embodiments, before the first information is sent, the method further includes:
receiving second information;
where the second information includes at least one of the following:
the second information is used for configuring the AI model or the AI function; and
the second information is used for indicating the terminal 101 to send the first information.

In some embodiments, after the first information is used for the network device 102 to determine to configure the AI model or the AI function, the method further includes:
receiving third information, where the third information is used for configuring the AI model or the AI function.

Based on some embodiments of the second aspect, in some embodiments, after the third information is received, the method further includes:
sending fourth information, where the fourth information is used for indicating that the terminal 101 accepts the AI model or the AI function configured by the third information, or the fourth information is used for indicating that the terminal rejects the AI model or the AI function configured by the third information.

In an embodiment of the present disclosure, step S3401 may be combined with step S3101, step S3103, or step S3104 of FIG. 3a, but is not limited to this.

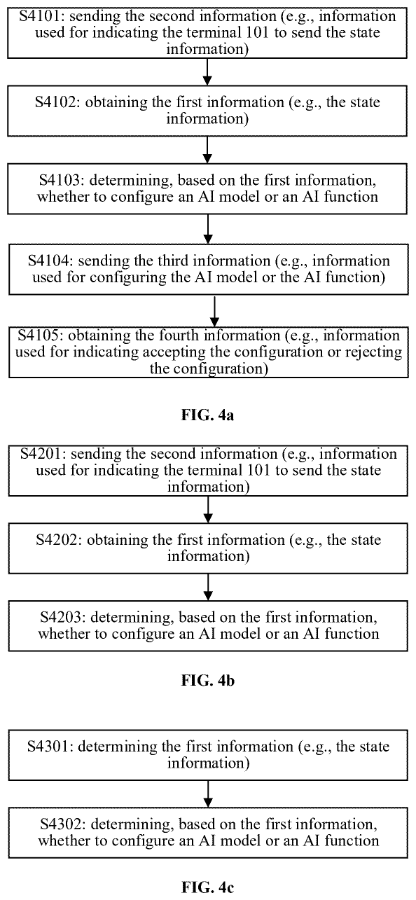

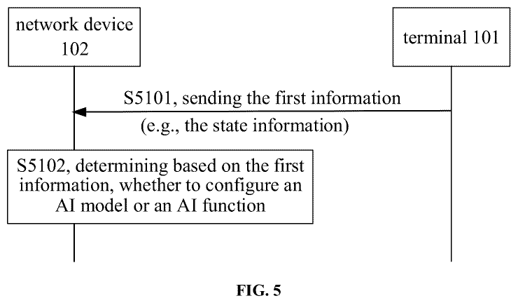

FIG. 4a is a flowchart of a communication method illustrated according to an embodiment of the present disclosure. As shown in FIG. 4a, the embodiment of the present disclosure relates to a communication method performed by the network device 102. The method described above includes the following steps S4101 to S4105.

At step S4101, the second information is sent.

The optional implementation of step S4101 may refer to the optional implementation of step S2101 in FIG. 2, and other related parts in the embodiments involved in FIG. 2, which will not be repeated here.

At step S4102, the first information is obtained.

The optional implementation of step S4102 may refer to the optional implementation of step S2102 in FIG. 2, and other related parts in the embodiments involved in FIG. 2, which will not be repeated here.

In some embodiments, the network device 102 receives the first information from the terminal 101, but may also receive the first information from other subjects.

In some embodiments, the network device 102 obtains the first information specified by the protocol.

In some embodiments, the network device 102 obtains the first information from the upper layer (s).

In some embodiments, the network device 102 performs processing to obtain the first information.

In some embodiments, step S4102 is omitted, and the network device 102 autonomously determines the first information.

At step S4103, whether to configure an AI model or an AI function is determined based on the first information.

The optional implementation of step S4103 may refer to the optional implementation of step S2103 in FIG. 2, and other related parts in the embodiments involved in FIG. 2, which will not be repeated here.

At step S4104, the third information is sent.

The optional implementation of step S4104 may refer to the optional implementation of step S2104 in FIG. 2, and other related parts in the embodiments involved in FIG. 2, which will not be repeated here.

At step S4105, the fourth information is obtained.

The optional implementation of step S4104 may refer to the optional implementation of step S2104 in FIG. 2, and other related parts in the embodiments involved in FIG. 2, which will not be repeated here.

In some embodiments, the network device 102 receives the fourth information from the terminal 101, but may also receive the fourth information from other subjects.

In some embodiments, the network device 102 obtains the fourth information specified by the protocol.

In some embodiments, the network device 102 obtains the fourth information from the upper layer(s).

In some embodiments, the network device 102 performs processing to obtain the fourth information.

In some embodiments, step S4105 is omitted, and the network device 102 autonomously determines the fourth information.

The communication method involved in the embodiments of the present disclosure may include at least one of steps S4101 to S4105. For example, step S4102 may be implemented as an independent embodiment, step S4103 may be implemented as an independent embodiment, step S4102+step S4103 may be implemented as an independent implementation example, step S4101+step S4102 may be implemented as an independent embodiment, step S4103+step S4104 may be implemented as an independent embodiment, step S4101+step S4102+step S4103 may be implemented as an independent embodiment, and step S4102+step S4103+step S4104 may be implemented as an independent embodiment, which is not limited thereto.

In some embodiments, step S4101 is optional, and one or more of these steps may be omitted or replaced in different embodiments.

In some embodiments, step S4104 is optional, and one or more of these steps may be omitted or replaced in different embodiments.

In some embodiments, step S4105 is optional, and one or more of these steps may be omitted or replaced in different embodiments.

FIG. 4b is a flowchart of a communication method illustrated according to an embodiment of the present disclosure. As shown in FIG. 4b, the embodiment of the present disclosure relates to a communication method performed by the network device 102. The method described above includes the following steps S4201 to S4203.

At step S4201, the second information is sent.

The optional implementation of step S4201 may refer to the optional implementation of step S2101 in FIG. 2, and other related parts in the embodiments involved in FIG. 2, which will not be repeated here. In an optional embodiment, the optional implementation of step S4201 may be found in step S4101 of FIG. 4a, and other related parts in the embodiments involved in FIG. 4a, which will not be repeated here.

At step S4202, the first information is obtained.

The optional implementation of step S4202 may refer to the optional implementation of step S2102 in FIG. 2, and other related parts in the embodiments involved in FIG. 2, which will not be repeated here. In an optional embodiment, the optional implementation of step S4202 may refer to step S4102 in FIG. 4a, and other related parts in the embodiments involved in FIG. 4a, which will not be repeated here.

At step S4203, whether to configure an AI model or an AI function for the terminal 101 is determined based on the first information.

The optional implementation of step S4203 may refer to the optional implementation of step S2103 in FIG. 2, and other related parts in the embodiments involved in FIG. 2, which will not be repeated here. In an optional embodiment, the optional implementation of step S4203 may be refer to step S4103 in FIG. 4a, and other related parts in the embodiments involved in FIG. 4a, which will not be repeated here.

The communication method involved in the embodiments of the present disclosure may include at least one of steps S4201 to S4103. For example, step S4201 may be implemented as an independent embodiment, step S4203 may be implemented as an independent embodiment, step S4201+step S4202 may be implemented as an independent embodiment, and step S4202+step S4203 may be implemented as an independent embodiment, which is not limited thereto [symbol] FIG. 4c is a flowchart of a communication method illustrated according to an embodiment of the present disclosure. As shown in FIG. 4c, the embodiment of the present disclosure relates to a communication method performed by the network device 102. The method includes the following steps S4301 to S4302.

At step S4301, the first information is determined.

In some embodiments, the network device 102 may receive the first information from the terminal 101, but may also receive the first information from other subjects.

In some embodiments, the first information is pre stored in the network device 102, and the network device 101 obtains the first information by downloading the first information.

In some embodiments, the network device 102 obtains the first information from the upper layer (s).

In some embodiments, the network device 102 determines the first information based on the protocol specification.

In some embodiments, the network device 102 performs processing to obtain the first information.

In some embodiments, the network device 102 autonomously determines the first information.

The optional implementation of step S4301 may refer to the optional implementation of step S2102 in FIG. 2, and other related parts in the embodiments involved in FIG. 2, which will not be repeated here. In an optional embodiment, the optional implementation of step S4301 may refer to step S4102 o in FIG. 4a, and other related parts in the embodiments involved in FIG. 4a, which will not be repeated here.

In some embodiments, the first information is used for determining the state of the terminal 101 for performing communication based on an AI model or an AI function.

In some embodiments, the first information is used for indicating at least one of the following:
the terminal 101 accepting an AI model or an AI function configured by the network device;
the terminal 101 rejecting the AI model or the AI function configured by the network device;
a total storage supported by the terminal 101;
a total computing power resource supported by the terminal 101;
an AI model or an AI function supported by the terminal 101;
a storage occupied by the AI model or the AI function supported by the terminal 101;
a computing power resource occupied by the AI model or the AI function supported by the terminal 101;
a maximum number of AI models or AI functions supported by the terminal 101;
a remaining computing power resource of the terminal 101;
a remaining storage of the terminal 101;
whether the terminal 101 expects to be configured with an AI model or an AI function;
a number of AI models or AI functions simultaneously supported by the terminal 101;
electric power amount information of the terminal 101; and
a condition under which the terminal 101 allows configuration of an AI model or an AI function.

At step S4302, whether to configure an AI model or an AI function is determined based on the first information.

The optional implementation of step S4302 may refer to the optional implementation of step S2103 in FIG. 2, and other related parts in the embodiments involved in FIG. 2, which will not be repeated here. In an optional embodiment, the optional implementation of step S4302 may refer to step S4103 in FIG. 4a, and other related parts in the embodiments involved in FIG. 4a, which will not be repeated here.

In some embodiments, the first information is used for indicating at least one of the following: a total storage supported by the terminal 101; a total computing power resource supported by the terminal 101; an AI model or an AI function supported by the terminal 101; a storage occupied by the AI model or the AI function supported by the terminal 101; and a computing power resource occupied by the AI model or the AI function supported by the terminal 101.

Determining, based on the first information, whether to configure the AI model or the AI function includes:
determining, based on the first information, the remaining storage and the remaining computing power resource of the terminal 101; and
determining, based on the remaining storage and the remaining computing power resource of the terminal 101, whether to configure the AI model or the AI function.

In some embodiments, determining, based on the remaining storage and the remaining computing power resource of the terminal 101, whether to configure the AI model or the AI function includes at least one of the following:
if the remaining storage and the remaining computing power resource of the terminal 101 support the terminal 101 in accepting the configured AI model or AI function, determining to configure the AI model or the AI function; and
if the remaining storage and the remaining computing power resource of the terminal 101 do not support the terminal 101 in accepting the configured AI model or AI function, determining not to configure the AI model or the AI function.

In some embodiments, the first information is used for indicating the maximum number of AI models or AI functions supported by the terminal 101.

Determining, based on the first information, whether to configure the AI model or the AI function includes at least one of the following:
if the maximum number of AI models or AI functions supported by the terminal 101 is less than or equal to the number of AI models or AI functions currently configured for the terminal 101 for performing communication, determining not to configure the AI model or the AI function; and
if the maximum number of AI models or AI functions supported by the terminal 101 is greater than the number of AI models currently configured for the terminal 101 for performing communication, determining to configure the AI model or the AI function.

In some embodiments, the first information is used for indicating at least one of the following: the terminal 101 accepting an AI model or an AI function configured by the network device 102, or the terminal 101 rejecting the AI model or the AI function configured by the network device 102.

Determining, based on the first information, whether to configure the AI model or the AI function includes at least one of the following: if the first information is used for indicating that the terminal 101 accepts the AI model or the AI function configured by the network device 102, determining to configure the AI model or the AI function; and
if the first information is used for indicating that the terminal 101 rejects the AI model or the AI function configured by the network device 102, determining not to configure the AI model or the AI function.

In some embodiments, the first information is used for indicating at least one of the following: a remaining computing power resource of the terminal 101, a remaining storage of the terminal 101, and whether the terminal 101 expects to be configured with an AI model or AI function.

Determining, based on the first information, whether to configure the AI model or the AI function includes at least one of the following:
if the remaining computing power resource and the remaining storage of the terminal 101 support the terminal 101 in accepting the configured AI model or AI function, and the terminal 101 expects to be configured with the AI model or the AI function, determining to configure the AI model or the AI function;
if the remaining computing power resource of the terminal 101 does not support the terminal 101 in accepting the configured AI model or AI function, determining not to configure the AI model or the AI function;
if the remaining storage of the terminal 101 does not support the terminal 101 in accepting the configured AI model or AI function, determining not to configure the AI model or the AI function; and
if the terminal 101 does not expect to be configured with the AI model or the AI function,
determining not to configure the AI model or the AI function.

In some embodiments, the first information is used for indicating the number of AI models or AI functions simultaneously supported by the terminal 101.

Determining, based on the first information, whether to configure the AI model includes: determining to configure the AI model or the AI function, where the number of configured AI models or AI functions is determined based on the number of AI models or AI functions simultaneously supported by the terminal 101.

In some embodiments, before the first information is determined, the method further includes: sending second information;
where the second information includes at least one of the following:
the second information is used for configuring the AI model or the AI function; and the second information is used for indicating the terminal 101 to send the first information.

In some embodiments, after the AI model or the AI function is determined to be configured, the method further includes:
sending third information, where the third information is used for configuring the AI model or the AI function.

In some embodiments, after the third information is sent, the method further includes:
receiving fourth information, where the fourth information is used for indicating that the terminal 101 accepts the AI model or the AI function configured by the third information, or the fourth information is used for indicating that the terminal 101 rejects the AI model or the AI function configured by the third information.

The communication method involved in the embodiments of the present disclosure may include at least one of steps S4301 to S4302. For example, step S4301 may be implemented as an independent embodiment, and step S4302 may be implemented as an independent embodiment, which is not limited thereto.

FIG. 5 is a flowchart of a communication method illustrated according to an embodiment of the present disclosure. As shown in FIG. 5, the embodiment of the present disclosure relates to a communication method for a communication system 100. The method described above includes the following steps S5101 to S5102.

At step S5101, the terminal 101 sends the first information to the network device.

In some embodiments, the first information is used for indicating the state of the terminal 101 for performing communication based on an AI model or an AI function.

In some embodiments, the first information is used for the network device to determining whether to configure an AI model or AI function.

The optional implementation of step S5101 may refer to the optional implementation of step S2102 in FIG. 2, and other related parts in the embodiments involved in FIG. 2. The optional implementation of step S5101 may refer to the optional implementation of step S3102 in FIG. 3a, and other related parts in the embodiments involved in FIG. 3a. The optional implementation of step S5101 may refer to the optional implementation of step S4102 in FIG. 4a, and other related parts in the embodiments involved in FIG. 4a.

At step S5102, the network device determines, based on the first information, whether to configure an AI model or AI function.

The optional implementation of step S5102 may refer to the optional implementation of step S2103 in FIG. 2, and other related parts in the embodiments involved in FIG. 2. The optional implementation of step S5101 may refer to the optional implementation of step S4103 in FIG. 4a, and other related parts in the embodiments involved in FIG. 4a.

In some embodiments, the above method may include the methods described in the embodiments related to the communication system 100, the terminal 101, and the network device 102, etc., which will not be repeated here.

An embodiment of the present disclosure also provides a communication method as follows.

Method 1: When configuring a certain model for the terminal 101, the network side sends a corresponding configuration signaling to the terminal 101. When the terminal 101 receives the configuration signaling, the terminal 101 determines the state of the terminal 101. Based on the determination result, the terminal 101 sends to the network the feedback for receiving or rejecting the configuration.

Method 2: When reporting the AI function or the AI model locally supported by the terminal 101, the terminal 101 reports the required storage and/or computing power. At the same time, the terminal 101 also reports the total storage and computing power supported by the terminal 101. The network side determines, based on the storage and computing power reported by the terminal 101, and the AI model and computing power configured for the terminal 101 in the current situation, whether the terminal 101 has spare capability to receive the new additional configuration. If yes, the network side initiates the configuration to the terminal 101; and if not, the network side does not initiate the configuration. At the terminal 101 side, based on other factors such as the amount of the electric power, the terminal 101 may still receive the configuration of the network or reject the configuration of the terminal 101.

Method 3: The terminal 101 side reports the maximum number of functions or AI models supported by the terminal 101. The network side determines whether there will be processing overload on the terminal 101 side based on the maximum number of functions or AI models supported by the terminal 101. If there is no processing overload, the base station may configure the AI model or the AI function at this time.

Method 4: Before configuring a certain AI function or AI model, the network side first initiates a state query to the terminal 101, which may specifically include the remaining computing power of the terminal 101, the remaining storage of the terminal 101, and the intention to configure another AI function or AI model. The network determines, based on the query result fed back from the terminal 101, whether to configure an AI model or an AI function for the terminal 101. Only when the terminal 101 satisfies the condition for allowing a certain AI model or AI function and has the running intention, the configuration is performed at this time.

Method 5: In response to the network configuring a plurality of AI functions or a plurality of AI models to the terminal 101, which facilitates dynamic selection or dynamic switching of the network side, when the terminal 101 is not capable of satisfying the processing of a plurality of AI functions or models, the terminal 101 may further provide feedback to the network on the number of AI functions or models that can be supported simultaneously by the terminal. At this time, the network may perform the reconfiguration.

In the embodiments of the present disclosure, the above methods and steps may be implemented as independent embodiments. Partial or complete methods, partial or complete steps, and their optional implementations may be combined arbitrarily with partial or complete steps in other embodiments, or with optional implementations in other embodiments.

An embodiment of the present disclosure also proposes a device for implementing any of the above methods. For example, a device is proposed, where the device includes a unit or module for implementing the steps performed by the terminal 101 in any of the above methods. For example, another device is proposed, where the device includes a unit or module for implementing the steps performed by the network device 102 (such as an access network device, a core network functional node, a core network device, etc.) in any of the above methods.

It should be understood that the division of units or modules in the above device is only a logical functional division. In actual implementations, they may be completely or partially integrated into a single physical entity, or they may be physically separated. Furthermore, the units or modules in the device may be implemented in the form of a processor invoking software, for example, the device includes a processor connected to a memory storing an instruction, and the processor invokes the instruction stored in the memory to implement any of the above methods or to implement the functions of the units or modules of the device. The processor is, for example, a general-purpose processor, such as a central processing unit (CPU) or a microprocessor, and the memory is either internal or external to the device. Alternatively, the units or modules in the device may be implemented in the form of hardware circuits. The functions of some or all of the units or modules may be implemented through the design of the hardware circuits, where the hardware circuits may be understood as one or more processors. For example, in one implementation, the hardware circuit is an application-specific integrated circuit (ASIC), and the functions of some or all of the units or modules are implemented through the design of the logical relationships between the components within the circuit. In another implementation, for example, the hardware circuit described above may be implemented by using a programmable logic device (PLD), such as a field programmable gate array (FPGA), which may include a large number of logic gate circuits. The connection relationships between the logic gate circuits are configured through a configuration file, thereby implementing the functions of some or all of the units or modules described above. All units or modules of the above device may be implemented entirely by a processor invoking software, or entirely by hardware circuits, or partially by a processor invoking software and the rest by hardware circuits. In the embodiments of the present disclosure, the processor is a circuit capable of signal processing. In one implementation, the processor may be a circuit capable of reading and executing instructions, such as a central processing unit (CPU), a microprocessor, a graphics processing unit (GPU) (which may be understood as a microprocessor), or a digital signal processor (DSP). In another implementation, the processor may implement certain functions through the logical relationships of hardware circuits, where the logical relationships of the aforementioned hardware circuits are fixed or reconfigurable. For example, the processor may be a hardware circuit implemented as an application-specific integrated circuit (ASIC) or a programmable logic device (PLD), such as an FPGA. In a reconfigurable hardware circuit, the process of the processor loading a configuration file to implement the hardware circuit configuration may be understood as the process of the processor loading instructions to implement the functions of some or all of the above units or modules. Alternatively, the processor may be a hardware circuit designed for artificial intelligence, which may be understood as an ASIC, such as a neural network processing unit (NPU), a tensor processing unit (TPU), or a deep learning processing unit (DPU), etc.

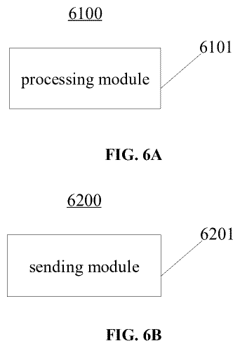

FIG. 6A is a schematic diagram of a structure of a first communication apparatus illustrated according to an embodiment of the present disclosure. As shown in FIG. 6A, the first communication apparatus 6100 includes a processing module 6101 configured to: determine first information, where the first information is used for determining a state of a terminal 101 for performing communication based on an AI model or an AI function; and determine, based on the first information, whether to configure an AI model or an AI function. Optionally, the processing module described above is configured to perform the processing related steps executed by the network device 102 in any of the above methods, which will not be repeated here. Optionally, the first communication apparatus 6100 further includes at least one of a sending module and a receiving module. The sending module described above is configured to perform the sending related steps executed by the network device 102 in any of the above methods, and the receiving module described above is configured to perform the receiving related steps executed by the network device 102 in any of the above methods, which will not be repeated here.

FIG. 6B is a schematic diagram of a structure of a second communication apparatus illustrated according to an embodiment of the present disclosure. As shown in FIG. 6B, the second communication apparatus 6200 includes a sending module 6201 configured to send first information, where the first information is used for indicating a state of a terminal 101 for performing communication based on an AI model or an AI function, and the first information is used for a network device to determine whether to configure an AI model or an AI function. Optionally, the sending module described above is configured to perform the sending related steps executed by the terminal 101 in any of the above methods, which will not be repeated here. Optionally, the second communication apparatus 6200 further includes at least one of a processing module and a receiving module. The processing module described above is configured to perform the processing related steps executed by the terminal 101 in any of the above methods, and the receiving module described above is configured to perform the receiving related steps executed by the terminal 101 in any of the above methods, which will not be repeated here.

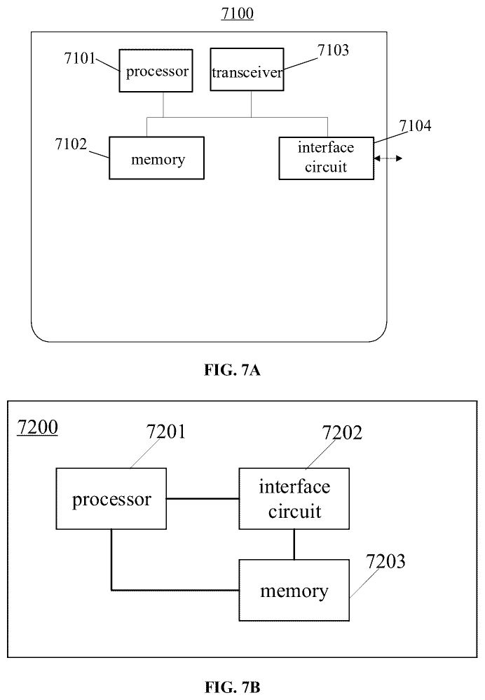

FIG. 7A is a schematic diagram of a structure of a communication device 7100 provided in an embodiment of the present disclosure. The communication device 7100 may be a network device 102 (e.g., an access network device, a core network device, etc.), a terminal 101 (e.g., a user equipment), or a chip, a chip system, or a processor that supports a network device 102 in implementing any of the above methods, or a chip, a chip system, or a processor that supports a terminal 101 in implementing any of the above methods. The communication device 7100 may be configured to implement the method described in the above method embodiments. For details, please refer to the description of the above method embodiments.

As shown in FIG. 7A, the communication device 7100 includes one or more processors 7101. The processor 7101 may be a general-purpose processor or a dedicated processor, such as a baseband processor or a central processing unit (CPU). The baseband processor may be configured to process communication protocols and communication data. The CPU may be configured to control a communication device (e.g., a base station, a baseband chip, a terminal device, a terminal device chip, a DU or a CU, etc.), execute programs, and process program data. The processor 7101 is configured to invoke instructions to cause the communication device 7100 to perform any of the above methods.

In some embodiments, the communication device 7100 further includes one or more memories 7102 for storing instructions. Optionally, all or a part of the memory 7102 may be located external to the communication device 7100.

In some embodiments, the communication device 7100 further includes one or more transceivers 7103. When the communication device 7100 includes one or more transceivers 7103, the communication steps such as sending and receiving in the above methods are performed by the transceiver 7103, while the other steps are performed by the processor 7101.

In some embodiments, the transceiver may include a receiver and a sender, which may be separated or integrated. Alternatively, terms such as the transceiver, the transceiver unit, the transceiver machine, and the transceiver circuit are interchangeable; terms such as the sender, the sending unit, the sender machine, and the sending circuit are interchangeable; and terms such as the receiver, the receiving unit, the receiver machine, and the receiving circuit are interchangeable.

Optionally, the communication device 7100 further includes one or more interface circuits 7104. The interface circuit 7104 is connected to the memory 7102 and may be configured to receive signals from the memory 7102 or other devices, and may be configured to send signals to the memory 7102 or other devices. For example, the interface circuit 7104 may read instructions stored in the memory 7102 and send the instructions to the processor 7101.

The communication device 7100 described in the above embodiments may be a network device 102 or a terminal 101, but the scope of the communication device 7100 described in the present disclosure is not limited thereto, and the structure of the communication device 7100 may not be limited to FIG. 7A. The communication device may be an independent device or a part of a larger device. For example, the communication device may be: (1) an independent integrated circuit (IC), or a chip, or a chip system or subsystem; (2) a collection of one or more ICs, optionally, the above IC collection may further include a storage component for storing data and programs; (3) an ASIC, such as a modem; (4) a module that can be embedded in other devices; (5) a receiver, a terminal device, an intelligent terminal device, a cellular phone, a wireless device, a handheld device, a mobile unit, an in-vehicle device, a network device 102, a cloud device, an artificial intelligence device, etc.; (6) others, etc.

FIG. 7B is a schematic diagram of a structure of a chip 7200 provided in an embodiment of the present disclosure. For the case where the communication device 7100 may be a chip or a chip system, the schematic diagram of the structure of the chip 7200 shown in FIG. 7B may be referred to, but is not limited to thereto.

The chip 7200 includes one or more processors 7201, and the processor 7201 is configured to invoke instructions to cause the chip 7200 to perform any of the above methods.

In some embodiments, the chip 7200 further includes one or more interface circuits 7202 connected to the memory 7203. The interface circuit 7202 may be configured to receive signals from the memory 7203 or other devices, or may be configured to send signals to the memory 7203 or other devices. For example, the interface circuit 7202 may read an instruction stored in the memory 7203 and send the instruction to the processor 7201. Optionally, the terms such as the interface circuit, the interface, the transceiver pin, and the transceiver, etc. are interchangeable.

In some embodiments, the chip 7200 further includes one or more memories 7203 for storing instructions. Optionally, all or a part of the memory 7203 may be located external to the chip 7200.

The present disclosure also provides a storage medium. The storage medium described above stores an instruction. The instruction, when run on the communication device 7100, causes the communication device 7100 to perform any of the above methods. Optionally, the storage medium described above is an electronic storage medium. Optionally, the storage medium described above is a computer-readable storage medium, but is not limited thereto. The storage medium may also be a storage medium readable by other devices. Optionally, the storage medium described above may be a non-transitory storage medium, but is not limited thereto. The storage medium described above may also be a transient storage medium.

The present disclosure also provides a program product that, when executed by the communication device 7100, causes the communication device 7100 to perform any of the above methods. Optionally, the program product is a computer program product.

The present disclosure also provides a computer program that, when executed on a computer, causes the computer to perform any of the above methods.

1. A communication method, performed by a network device, comprising:
determining first information, wherein the first information is used for determining a state of a terminal for performing communication based on an artificial intelligence (AI) model or an AI function; and
determining, based on the first information, whether to configure the AI model or the AI function.

2. The method according to claim 1, wherein the first information is used for indicating at least one of:
the terminal accepting an AI model or an AI function configured by the network device;
the terminal rejecting the AI model or the AI function configured by the network device;
a total storage supported by the terminal;
a total computing power resource supported by the terminal;
an AI model or an AI function supported by the terminal;
a storage occupied by the AI model or the AI function supported by the terminal;
a computing power resource occupied by the AI model or the AI function supported by the terminal;
a maximum number of AI models or AI functions supported by the terminal;
a remaining computing power resource of the terminal;
a remaining storage of the terminal;
whether the terminal expects to be configured with an AI model or an AI function;
a number of AI models or AI functions simultaneously supported by the terminal;
electric power amount information of the terminal; or
a condition under which the terminal allows configuration of an AI model or an AI function.

3. The method according to claim 1, wherein the determining the first information comprises:
receiving the first information.

4. The method according to claim 1, wherein the first information is used for indicating at least one of: a total storage supported by the terminal; a total computing power resource supported by the terminal; an AI model or an AI function supported by the terminal; a storage occupied by the AI model or the AI function supported by the terminal; or a computing power resource occupied by the AI model or the AI function supported by the terminal; and
the determining, based on the first information, whether to configure the AI model or the AI function comprises:
determining, based on the first information, a remaining storage and a remaining computing power resource of the terminal; and
determining, based on the remaining storage and the remaining computing power resource of the terminal, whether to configure the AI model or the AI function.

5. The method according to claim 4, wherein the determining, based on the remaining storage and the remaining computing power resource of the terminal, whether to configure the AI model or the AI function comprises at least one of:
in response to the remaining storage and the remaining computing power resource of the terminal supporting the terminal in accepting the AI model or the AI function configured by the network device, determining to configure the AI model or the AI function; or
in response to the remaining storage and the remaining computing power resource of the terminal not supporting the terminal in accepting the model or the AI function configured by the network device, determining not to configure the AI model or the AI function.

6. The method according to claim 1, wherein the first information is used for indicating a maximum number of AI models or AI functions supported by the terminal; and
the determining, based on the first information, whether to configure the AI model or the AI function comprises at least one of:
in response to the maximum number of AI models or AI functions supported by the terminal being less than or equal to a number of AI models or AI functions currently configured for the terminal for performing communication, determining not to configure the AI model or the AI function; or
in response to the maximum number of AI models or AI functions supported by the terminal being greater than the number of AI models or AI functions currently configured for the terminal for performing communication, determining to configure the AI model or the AI function.

7. The method according to claim 1, wherein the first information is used for indicating at least one of: the terminal accepting an AI model or an AI function configured by the network device, or the terminal rejecting the AI model or the AI function configured by the network device; and
the determining, based on the first information, whether to configure the AI model or the AI function comprises at least one of:
in response to the first information indicating that the terminal accepts the AI model or the AI function configured by the network device, determining to configure the AI model or the AI function; or
in response to the first information indicating that the terminal rejects the AI model or the AI function configured by the network device, determining not to configure the AI model or the AI function.

8. The method according to claim 1, wherein the first information is used for indicating at least one of: a remaining computing power resource of the terminal, a remaining storage of the terminal, or whether the terminal expects to be configured with an AI model or an AI function; and
the determining, based on the first information, whether to configure the AI model or the AI function comprises at least one of:
in response to the remaining computing power resource and the remaining storage of the terminal supporting the terminal in accepting the AI model or the AI function configured by the network device, and the terminal expecting to be configured with the AI model or the AI function, determining to configure the AI model or the AI function;
in response toif the remaining computing power resource of the terminal not supporting the terminal in accepting the AI model or the AI function configured by the network device, determining not to configure the AI model or the AI function;
in response to the remaining storage of the terminal not supporting the terminal in accepting the model or the AI function configured by the network device, determining not to configure the AI model or the AI function; or
in response to the terminal not expecting to be configured with the AI model or the AI function, determining not to configure the AI model or the AI function.

9. The method according to claim 1, wherein the first information is used for indicating a number of AI models or AI functions simultaneously supported by the terminal; and
the determining, based on the first information, whether to configure the AI model or the AI function comprises:
determining to configure the AI model or the AI function, wherein a number of configured AI models or AI functions is determined based on the number of AI models or AI functions simultaneously supported by the terminal.

10. The method according to claim 1,
further comprising:
sending second information; wherein
the second information is used for at least one of:
configuring the AI model or the AI function; or
indicating the terminal to send the first information; or
sending third information, wherein the third information is used for configuring the AI model or the AI function.

11. (canceled)

12. The method according to claim 10, further comprising:
receiving fourth information, wherein the fourth information is used for indicating that the terminal accepts the AI model or the AI function configured by the third information, or the fourth information is used for indicating that the terminal rejects the AI model or the AI function configured by the third information.

13. A communication method, performed by a terminal, comprising:
sending first information, wherein the first information is used for indicating a state of the terminal for performing communication based on an artificial intelligence (AI) model or an AI function, and the first information is used for a network device to determine whether to configure the AI model or the AI function.

14. (canceled)

15. The method according to claim 13, wherein the first information is used for indicating at least one of: a total storage supported by the terminal; a total computing power resource supported by the terminal; an AI model or an AI function supported by the terminal; a storage occupied by the AI model or the AI function supported by the terminal; or a computing power resource occupied by the AI model or the AI function supported by the terminal; and
the first information is used for the network device to determine a remaining storage and a remaining computing power resource of the terminal, and is used for the network device to determine, based on the remaining storage and the remaining computing power resource of the terminal, whether to configure the AI model or the AI function.

16. The method according to claim 15, wherein
in response to the remaining storage and the remaining computing power resource of the terminal supporting the terminal in accepting the AI model or the AI function configured by the network device, the first information is used for the network device to determine to configure the AI model or the AI function; or
in response to the remaining storage and the remaining computing power resource of the terminal not supporting the terminal in accepting the AI model or the AI function configured by the network device, the first information is used for the network device to determine not to configure the AI model or the AI function.

17. The method according to claim 13, wherein the first information is used for indicating a maximum number of AI models or AI functions supported by the terminal;
wherein:
in response toif the maximum number of AI models or AI functions supported by the terminal being less than or equal to a number of AI models or AI functions currently configured for the terminal for performing communication, the first information is used for the network device to determine not to configure the AI model or the AI function; or
in response to the maximum number of AI models or AI functions supported by the terminal being greater than the number of AI models or AI functions currently configured for the terminal for performing communication, the first information is used for the network device to determine to configure the AI model or the AI function; or
wherein the first information is used for indicating that the terminal accepts an AI model or an AI function configured by the network device, or that the terminal rejects the AI model or the AI function configured by the network device;
wherein:
in response to the first information indicating that the terminal accepts the AI model or the AI function configured by the network device, the first information is used for indicating the network device to determine to configure the AI model or the AI function; or
in response to the first information indicating that the terminal rejects the AI model or the AI function configured by the network device, the first information is used for indicating the network device to determine not to configure the AI model or the AI function.

18. (canceled)

19. The method according to claim 13, wherein the first information is used for indicating at least one of: a remaining computing power resource of the terminal, a remaining storage of the terminal, or whether the terminal expects to be configured with an AI model or an AI function;
wherein:
in response to the remaining computing power resource and the remaining storage of the terminal supporting the terminal in accepting the AI model or the AI function configured by the network device, and the terminal expecting to be configured with the AI model or the AI function, the first information is used for indicating the network device to determine to configure the AI model or the AI function;
in response toif the remaining computing power resource of the terminal supporting the terminal in accepting the model or the AI function configured by the network device, the first information is used for indicating the network device to determine not to configure the AI model or the AI function;
in response to the remaining storage of the terminal not supporting the terminal in accepting the AI model or the AI function configured by the network device, the first information is used for indicating the network device to determine not to configure the AI model or the AI function; or
in response to the terminal does not expecting to be configured with the AI model or the AI function, the first information is used for indicating the network device to determine not to configure the AI model or the AI function; or
wherein the first information is used for indicating a number of AI models or AI functions simultaneously supported by the terminal; and the first information is used for the network device to determine to configure the AI model or the AI function, and a number of configured AI models or AI functions is determined based on the number of AI models or AI functions simultaneously supported by the terminal.

20. (canceled)

21. The method according to claim 13, further comprising:
receiving second information; wherein
the second information is used for at least one of:
configuring the AI model or the AI function; or
indicating the terminal to send the first information; or
receiving third information, wherein the third information is used for configuring the AI model or the AI function.

22. (canceled)

23. The method according to claim 21, wherein further comprising:
sending fourth information, wherein the fourth information is used for indicating that the terminal accepts the AI model or the AI function configured by the third information, or the fourth information is used for indicating that the terminal rejects the AI model or the AI function configured by the third information.

24.-26. (canceled)

27. A communication device, comprising:
one or more processors; wherein
the processor, through invoking an instruction, is cconfigured to:
determine first information, wherein the first information is used for determining a state of a terminal for performing communication based on an artificial intelligence (AI) model or an AI function; and
determine, based on the first information, whether to configure the AI model or the AI function.

28. (canceled)

29. A non-transitory storage medium, storing an instruction that, when run on a communication device, causes the communication device to perform the communication method according to claim 1.
